(19) United States
(12) Patent Application Publication
(10) Pub. No.: US 2019/0253743 A1
(43) Pub. Date: Aug. 15, 2019

(54) INFORMATION PROCESSING DEVICE, INFORMATION PROCESSING SYSTEM, AND INFORMATION PROCESSING METHOD, AND COMPUTER PROGRAM

(71) Applicant: SONY CORPORATION, Tokyo (JP)

(72) Inventors: Tomohisa TANAKA, Tokyo (JP); Yusuke SESHITA, Tokyo (JP)

(73) Assignee: SONY CORPORATION, Tokyo (JP)

(21) Appl. No.: 16/333,326

(22) PCT Filed: Sep. 27, 2017
(86) PCT No.: PCT/JP2017/034884

§ 371 Date: Mar. 14, 2019

(30) Foreign Application Priority Data
Oct. 26, 2016 (JP) 2016-209294

(51) Int. Cl. H04N 21/24; H04N 13/383; H04N 13/117; G06Q 30/02; H04N 21/81

(52) U.S. Cl. CPC H04N 21/2407; H04N 13/383; H04N 21/812; G06Q 30/0246; G06Q 30/0249; H04N 13/117

(57) ABSTRACT

A viewpoint position heat map illustrating a distribution status of viewpoint positions of users viewing a content is generated to enable content and advertisement distribution control by using the heat map. A server transmits, to a client, a free viewpoint video content that allows video to be observed in accordance with a viewpoint position and a sight line direction. The client generates viewing status information including temporal sequence data of the viewpoint positions and sight line directions of the users viewing the content, and transmits the viewing status information to the server. The server receives the viewing status information from a plurality of clients, and generates a viewpoint position heat map illustrating a distribution status of the viewpoint positions of the viewing users, and a gaze point position heat map illustrating a distribution status of gaze point positions of the viewing users.

### TECHNICAL FIELD

The present disclosure relates to an information processing device, an information processing system, and an information processing method, and a computer program. More specifically, the present disclosure relates to an information processing device, an information processing system, and an information processing method, and a computer program that acquire user observation position information and the like for free viewpoint video that allows observation of video in various directions, such as entire celestial video, omnidirectional video, or panorama video, and perform control or the like of video provided to a viewer.

### BACKGROUND ART

In a widely used system, an image in various directions, such as entire celestial video, omnidirectional video, and panorama video is displayed on a display unit of a PC, a tablet terminal, a portable terminal, a head-mounted display (HMD), or the like to allow observation of an image selected by a user or video automatically selected in accordance with the orientation of the user.

Note that video that allows presentation of video in various directions selected by a user is referred to as “free viewpoint video”.

For example, a PC or the like can acquire from an external server or read from a record media, video (moving image) data of an omnidirectional video of 360 degrees, and can display the video on a display device. A user can select a video of an optional direction and display the video on the display device, and can freely change a viewpoint when observing an image such as a moving image or a still image.

The video displayed on the display unit of a PC, a tablet terminal, or a portable terminal can be displayed with the observation direction changed through, for example, a mouse operation, or slide processing or flick processing on a touch panel by the user, and the user can easily enjoy the video in various directions.

In a case where video is displayed on a head-mounted display (HMD), the video can be displayed in accordance with the direction of the head of the user in accordance with information from a sensor mounted on the HMD and configured to detect the motion and direction of the head, and the user can enjoy feeling as if the user exists in the video displayed on the display unit of the HMD.

Such a free viewpoint video allows observation video switching through a user operation or the like, and thus there sometimes occurs a video region observed by a large number of users and a hardly observed video region.

In other words, there exist a video region having a high viewing rate and a video region having a low viewing rate.

Processing of analyzing, for example, a video region having a high viewing rate, and the like can be performed as data analysis based on such a characteristic unique to the free viewpoint video, and a result of the analysis can be used to perform, for example, more effective content provision processing, advertisement provision processing, and charge processing.

Patent Document 1 (Japanese Patent Application Laid-open No. 2013-183209: “Multiview Video Stream Viewing System and Method”) discloses a configuration in which popular images and videos are analyzed by recording a viewpoint switching operation in a system in which a viewer can optionally select and switch which of a plurality of video streams is to be watched.

Furthermore, Patent Document 2 (Japanese Patent Application Laid-open No. 2013-255210: “Video Display Method, Video Display Device, and Video Display Program”) discloses a configuration in which, in a system configured to provide a content that allows a viewer to select and view a desired region of a panorama video, region selection information of the viewer is recorded to display any past selection region when viewing the same video again.

Note that the free viewpoint video includes a plurality of different kinds of videos. Most of a multi-viewpoint video, a panorama video, an entire celestial video, and the like, which are conventionally available, have a configuration in which only the direction can be changed while the viewpoint position is fixed.

For such a content, in a case where it is analyzed which part of the video the viewer watches, only the direction needs to be analyzed.

However, recently, a free viewpoint video, such as a display video for a head-mounted display (HMD), that allows change of both of the viewpoint position and the viewpoint direction has been increasngly widely used.

Temporally sequential information on which direction the viewer watches in from which viewpoint position is needed to perform viewing region analysis on such a free viewpoint video that allows change of both of the viewpoint position and the viewpoint direction. However, no clear method has been established for such analysis processing.

### CITATION LIST

### Patent Document

Patent Document 1: Japanese Patent Application Laid-open No. 2013-183209

Patent Document 2: Japanese Patent Application Laid-open No. 2013-255210

### SUMMARY OF THE INVENTION

### Problems to be Solved by the Invention

The present disclosure is intended to solve, for example, the above-described problem and provide an information processing device, an information processing system, and an information processing method, and a computer program that acquire and analyze user observation position information and the like for a free viewpoint video that allows observation of video in various directions, such as entire celestial video, omnidirectional video, or panorama video.

Furthermore, an embodiment of the present disclosure is intended to provide an information processing device, an information processing system, and an information processing method, and a computer program that acquire and analyze temporally sequential viewing information of an image region observed by a viewer on a free viewpoint video, such as a display video for a head-mounted display (HMD), that allows change of both of the viewpoint position and the viewpoint direction, and perform provided video control and the like in accordance with a result of the analysis.

### Solutions to Problems

A first aspect of the present disclosure is an information processing device including a data processing unit configured to:

acquire information on viewpoint positions of a plurality of users viewing a content; and

generate a viewpoint position heat map illustrating a distribution status of the viewpoint positions of the users.

Furthermore, a second aspect of the present disclosure is an information processing system including a server and a client, in which

the server transmits, to the client, a free viewpoint video content that allows video to be observed in accordance with at least one of a viewpoint position or a sight line direction,

the client generates viewing status information including temporal sequence data of a viewpoint position and a sight line direction of a user viewing the content and transmits the viewing status information to the server, and

the server receives the viewing status information from a plurality of clients, and generates at least one heat map of
the viewpoint position heat map illustrating the distribution status of the viewpoint positions of the users viewing the content, or
a gaze point position heat map illustrating a distribution status of gaze point positions of the users viewing the content.

Furthermore, a third aspect of the present disclosure is an information processing device configured to:

execute processing of receiving, from a server, a free viewpoint video content that allows video to be observed in accordance with at least one of a viewpoint position or a sight line direction and displaying the free viewpoint video content; and

further generate viewing status information including temporal sequence data of a viewpoint position and a sight line direction of a user viewing the free viewpoint video content and transmit the viewing status information to the server.

Furthermore, a fourth aspect of the present disclosure is an information processing method of executing information processing at an information processing device, in which a data processing unit of the information processing device:

acquires information on viewpoint positions of a plurality of users viewing a content; and

generates a viewpoint position heat map illustrating a distribution status of the viewpoint positions of the users.

Furthermore, a fifth aspect of the present disclosure is a computer program that causes an information processing device to execute information processing, the computer program causing a data processing unit of the information processing device to execute:

processing of acquiring information on viewpoint positions of a plurality of users viewing a content; and

processing of generating a viewpoint position heat map illustrating a distribution status of the viewpoint positions of the users.

Note that the program of the present disclosure is a program that can be provided by a storage medium or a communication medium provided in a computer readable form to an information processing apparatus or a computer system that can execute various program codes, for example. By providing such a program in a computer readable format, processing according to the program is realized on the information processing apparatus or the computer system.

Still other objects, features, and advantages of the present disclosure will become apparent from the detailed description based on embodiments of the present disclosure and attached drawings to be described later. Note that, in this specification, the term “system” refers to a logical group configuration of a plurality of apparatuses, and is not limited to a system in which the apparatuses of each configuration are in the same housing.

### Effects of the Invention

With a configuration according to an embodiment of the present disclosure, a viewpoint position heat map illustrating a distribution status of viewpoint positions of users viewing a content is generated to enable content and advertisement distribution control by using the heat map.

Specifically for example, a server transmits, to a client, a free viewpoint video content that allows video to be observed in accordance with a viewpoint position and a sight line direction. The client generates viewing status information including temporal sequence data of the viewpoint positions and sight line directions of the users viewing the content, and transmits the viewing status information to the server. The server receives the viewing status information from a plurality of clients, and generates a viewpoint position heat map illustrating a distribution status of the viewpoint positions of the viewing users, and a gaze point position heat map illustrating a distribution status of gaze point positions of the viewing users. In addition, for example, content distribution control and advertisement distribution control are executed in accordance with the heat maps.

With this configuration, a viewpoint position heat map illustrating a distribution status of viewpoint positions of users viewing a content is generated to enable content and advertisement distribution control by using the heat map.

Note that effects written in the present specification are merely exemplary and the present invention is not limited thereto, but may have additional effects.

### BRIEF DESCRIPTION OF DRAWINGS

FIG. 1 is a diagram for description of an exemplary configuration of an information processing system.

FIG. 2 is a diagram for description of exemplary use of a viewing device.

FIG. 3 is a diagram for description of exemplary data of viewing status information.

FIG. 4 is a diagram for description of a specific example of data of the viewing status information.

FIG. 5 is a diagram for description of a gaze point.

FIG. 6 is a diagram for description of an exemplary gaze point position heat map.

FIG. 7 is a diagram for description of an exemplary configuration of a three-dimensional heat map.

FIG. 8 is a diagram for description of an exemplary head position (viewpoint position) heat map.

FIG. 9 is a diagram illustrating a flowchart for description of a generation sequence of the head position (viewpoint position) heat map.

FIG. 10 is a diagram illustrating a flowchart for description of the generation sequence of the head position (viewpoint position) heat map.

FIG. 11 is a diagram for description of a specific example of the head position (viewpoint position) heat map.

FIG. 12 is a diagram illustrating a flowchart for description of a generation sequence of the gaze point position heat map.

FIG. 13 is a diagram illustrating a flowchart for description of the generation sequence of the gaze paint position heat map.

FIG. 14 is a diagram for description of a specific example of the gaze point position heat map.

FIG. 15 is a diagram for description of an exemplary configuration of the information processing system.

FIG. 16 is a diagram for description of an exemplary viewing device.

FIG. 17 is a diagram for description of exemplary recommended viewpoint information.

FIG. 18 is a diagram for description of exemplary switching between viewpoint control modes of the viewing device.

FIG. 19 is a diagram illustrating a flowchart for description of a processing sequence using the recommended viewpoint information.

FIG. 20 is a diagram illustrating a flowchart for description of the processing sequence using the recommended viewpoint information.

FIG. 21 is a diagram for description of an exemplary configuration of the information processing system.

FIG. 22 is a diagram for description of exemplary scene switch point information.

FIG. 23 is a diagram illustrating a flowchart for description of a processing sequence using the scene switch point information.

FIG. 24 is a diagram illustrating a flowchart for description of the processing sequence using the scene switch point information.

FIG. 25 is a diagram for description of an exemplary advertisement rank definition list.

FIG. 26 is a diagram for description of exemplary advertisement database storage data.

FIG. 27 is a diagram for description of as exemplary configuration of the information processing system.

FIG. 28 is a diagram illustrating a flowchart for description of a sequence of advertisement provision processing.

FIG. 29 is a diagram for description of an exemplary configuration of the information processing system.

FIG. 30 is a diagram illustrating a flowchart for description of a processing sequence using an encode control content.

FIG. 31 is a diagram illustrating a flowchart for description of the processing sequence using the encode control content.

FIG. 32 is a diagram for description of exemplary charge setting data.

FIG. 33 is a diagram for description of an exemplary configuration of the information processing system.

FIG. 34 is a diagram illustrating a flowchart for description of a processing sequence in a case where charge processing is executed.

FIG. 35 is a diagram for description of an exemplary configuration of the information processing system.

FIG. 36 is a diagram for description of an exemplary hardware configuration of an information processing device.

### MODE FOR CARRYING OUT THE INVENTION

The following describes an information processing device, an information processing system, and an information processing method, and a computer program of the present disclosure in detail with reference to the accompanying drawings. Note that the description will be made in accordance with an order as follows.

1. Overview of processing executed by information processing system of the present disclosure

2-(a). Embodiment of generation of gaze point position heat map and head position heat map

2-(b). Embodiment of provision of recommended viewpoint information and execution of display control based on recommended viewpoint information

2-(c). Embodiment of execution of content automatic chapter division processing

2-(d). Embodiment of execution of advertisement display control

2-(e). Embodiment of execution of image quality control in accordance with attention degree

2-(f). Embodiment of execution of charge processing based on viewing status analysis result

2-(g). Embodiment of attention region analysis of audience of concert, movie film, and the like

3. Exemplary hardware configuration of information processing device

4. Summary of the present disclosure configuration.

### [1. Overview of Processing Executed by Information Processing System of the Present Disclosure]

The following first describes overview of processing executed by an information processing system of the present disclosure.

As described above, in a widely used system, video in various directions, such as entire celestial video, omnidirectional video, or panorama video is displayed on a display unit of a PC, a tablet terminal, a portable terminal, a head-mounted display (HMD), or the like to allow observation of video selected by a user or video automatically selected in accordance with the orientation of the user.

Note that, as described above, video that allows presentation of video in various directions selected by a user is referred to as “free viewpoint video”.

A video content provided to a viewer in the information processing system of the present disclosure is a content that allows the viewer to freely specify the position and direction of a viewpoint.

Note that the content may be, for example, any of a live content distributed in a streaming manner or a recorded content downloaded or recorded in a media (information recording medium) in advance and distributed.

In the information processing system of the present disclosure, when a free viewpoint video content that allows observation of video in accordance with at least one of a viewpoint position or a sight line direction is played back at a client (information processing device on the viewer side), the client records, as temporally sequential information, information (viewing status information) on which position the viewer is watching at in which direction.

The “viewing status information” recorded by the client (information processing device on the viewer side) is transmitted to an information processing device (server) that performs data analysis processing in real time or collectively later.

The server stores, in a database, the viewing status information received from a large number of clients (viewer side devices).

The server analyzes the viewing status information accumulated in the database, and acquires statistics information such as the viewing position (head position) and the sight line direction of the viewer, and a field of view (FoV) as viewing region information at each time. The server further generates, on the basis of the statistics information,

(1) gaze point information on which position of the content is watched a large number of times,

(2) Information on the head position (viewpoint position) of the viewer relative to the content, and

a map such as a three-dimensional heat map from which these pieces of information can be swiftly recognized.

The server receives the viewing status information from a large number of viewers viewing the same content through, for example, a network, and performs analysis processing.

Processing executed by an information processing device such as a server, or an information processing system in the present disclosure is, for example, as follows.

### (a) Generation of a Gaze Point Position Heat Map and a Head Position Heat Map

A heat map with which statistics information of a viewing region of a content and the viewpoint position (head position) of a user can be recognized is generated.

(b) Provision of Recommended Viewpoint Information and Execution of Display Control Based on Recommended Viewpoint Information

A content in a video region at a most popular viewpoint position in a sight line direction at each time is automatically displayed on the basis of a viewing status analysis result.

Through this content control, a high video or the like of a large number of viewers can be preferentially provided.

(c) Execution of Content Automatic Chapter Division Processing

Specifically, a scene switch point is detected on the basis of a viewing status analysis result, for example, the degree of temporally sequential change of a heat map, and is set as a chapter switching point.

(d) Execution of Advertisement Display Control

Specifically, a video region in which a viewer pays attention in a content is extracted on the basis of a viewing status analysis result, for example, a heat map, a “viewing rate” is calculated for each video region in a free viewpoint video, and the following processing is performed on the basis of the viewing rate.

In a case where an advertisement is superimposed on a content and provided, and an advertisement rate is automatically calculated on the basis of the viewing rate.

(e) Image Quality Control in Accordance with an Attention Degree is Executed

Specifically, for example, an encode bit rate is controlled on the basis of a viewing status analysis result. Such encode control is executed on the basis of a heat map that the texture of an object with a high attention degree is encoded at a higher bit rate, and the texture of an object with not so much attention is encoded at a low bit rate.

(f) Charge Processing Based on a Viewing Status Analysis Result is Executed.

The viewing rate of each video region is calculated on the basis of a heat map, a high charge is placed on playback of a popular image region with a high viewing rate, and a low charge is placed on playback of an unpopular video region. Setting of a content viewing price is automated.

(g) Attention Regions of Audience of a Concert, a Movie Film, and the Like Are Analyzed.

The audience of a concert, a movie film, and the like wears a sight line detection instrument (such as a HMD), sight line information or the like of the audience is acquired and analyzed.

The information processing device such as a server, and the information processing system in the present disclosure execute, for example, the processing (a) to (g) described above.

The following sequentially describes specific exemplary configuration and exemplary processing for executing the above-described processing (a) to (g) of embodiments.

[2-(a). Embodiment of Generation of Gaze Point Position Heat Map and Head Position Heat Map]

The following first describes an embodiment in which a gaze point position heat map and a head position heat map as content viewing status analysis information are generated.

Processing described below is processing of generating a heat map with which statistics information on a content viewing region and a user viewpoint position (head position) can be recognized.

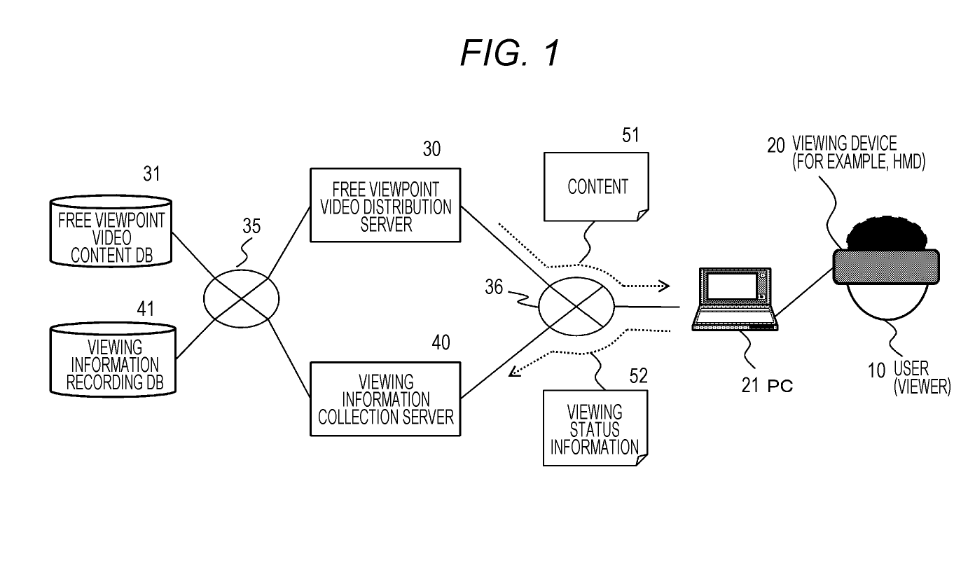

FIG. 1 is a diagram illustrating an exemplary configuration of the information processing system of the present disclosure.

A user (content viewer) 10 wears a viewing device 20. The viewing device 20 is, for example, a head-mounted display (HDM).

The viewing device 20 displays video in accordance with the orientation and the sight line direction of the user 10.

Specifically, a “free viewpoint video” that allows presentation of various direction video such as entire celestial video, omnidirectional video, and panorama video, is displayed.

The viewing device 20 includes a sensor configured to detect the position and orientation (head position and direction) of the user (viewer) 10, and a sensor configured to detect the sight line of the user 10.

The sensor configured to detect the position and orientation (head position and direction) of the user 10 is achieved by an existing sensor such as a gyroscopic sensor, a stereo camera, or the like.

The sensor configured to detect the sight line of the user 10 can be achieved by an existing sight line detection sensor that uses, for example, pupil cornea reflection or the like.

The sight line detection sensor detects the sight line direction of the user 10 from, for example, the rotation center positions of the right and left eyeballs and the orientations of the visual axes (and the head posture).

Note that a sensor configured to detect the posture of the head simply by head tracking and determine a head forward direction to be a sight line direction may be used.

In this case, the head forward direction and the sight line direction align with each other.

Information on the position (head position) and sight line direction of a user detected by a sensor mounted on the viewing device 20 is sequentially transmitted from the viewing device 20 to a PC 21.

The viewing device 20 includes, for example, a 3D display that that allows the user (viewer) 10 to view, as a stereoscopic image, a free viewpoint video with both eyes.

A rendered image (moving image) by the PC 21 is displayed on the display of the viewing device 20.

The PC 21 receives a free viewpoint video content 51 provided from a free viewpoint video distribution server 30 through a network 36, cuts out an image region to be displayed on the viewing device 20, outputs the image region to the viewing device 20, and displays the image region on the display.

Note that FIG. 1 only illustrates the single user (viewer) 10, the single viewing device 20, and the single PC 21, but the network 36 is connected with a large number of PCs 21, and a large number of users (viewers) are viewing the content 51 by using viewing devices 20.

Furthermore, a display device configured to perform content output on the user (viewer) 10 side is not limited to a HMD, but may be a portable terminal such as a PC, a television, a smartphone, or the like, for example.

The image cutout processing by the PC 21 is performed as described below.

A display image region is specified in accordance with an own position received from the viewing device 20, and a view angle, in other words, a field of view (FoV) predetermined for the viewing device 20, and the specified image region is cut out from the free viewpoint video content 51 provided from the free viewpoint video distribution server 30, output to the viewing device 20, and displayed on the display.

The user (viewer) 10 observing video displayed on the display of the viewing device 20 can freely control viewing position and direction by changing the head posture.

Note that various metadata is set to the content 51 provided from the free viewpoint video distribution server 30.

The metadata includes, for example, definition information of a viewing frustum that defines the image region of the display image. The metadata includes, for example, information on “near clip” constituting a user side plane constituting the viewing frustum and “far clip” constituting a plane separated from the user.

A data processing unit of the PC 21 can determine the viewing frustum necessary for rendering by using the FoV predetermined for the viewing device 20 and these metadata.

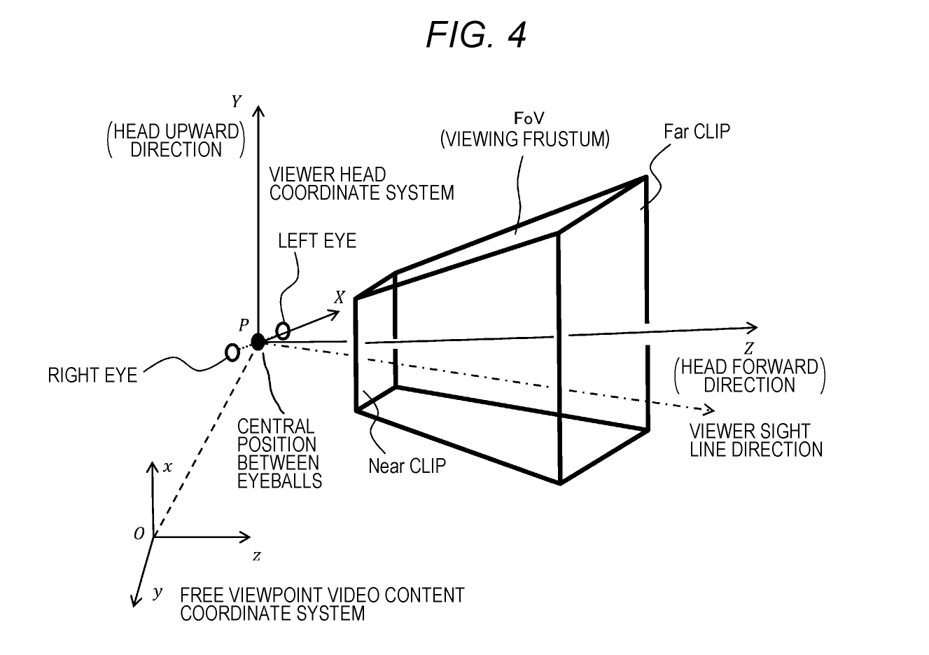

Note that details of the viewing frustum, the “near clip”, and the “far clip” will be further described later with reference to FIG. 4.

As described above, the free viewpoint video content 51 is distributed by streaming from the free viewpoint video distribution server 30 through, for example, the network 36.

The free viewpoint video content 51 is, for example, a content stored in a free viewpoint video content database 31, and the free viewpoint video distribution server 30 reads a content from the free viewpoint video content database 31 through a network 35 and transmits the content to the PC 21 on the user (viewer) 10 side.

Note that uniquely determined viewer ID and content ID are allocated to the user (viewer) 10 and the content 51, respectively.

The PC 21 records the head position (viewpoint position), the posture (head forward direction, head upper part direction), the sight line direction, and the FoV of the user (viewer) 10 at each time in playback of the content 51, generates viewing status information 52, and sequentially transmits the viewing status information 52 to a viewing status information collection server 40.

The viewing status information collection server 40 receives the viewing status information 52 from the PC 21 through the network 36, and stores and records the received viewing status information 52 in a viewing information record database 41 connected through the network 35.

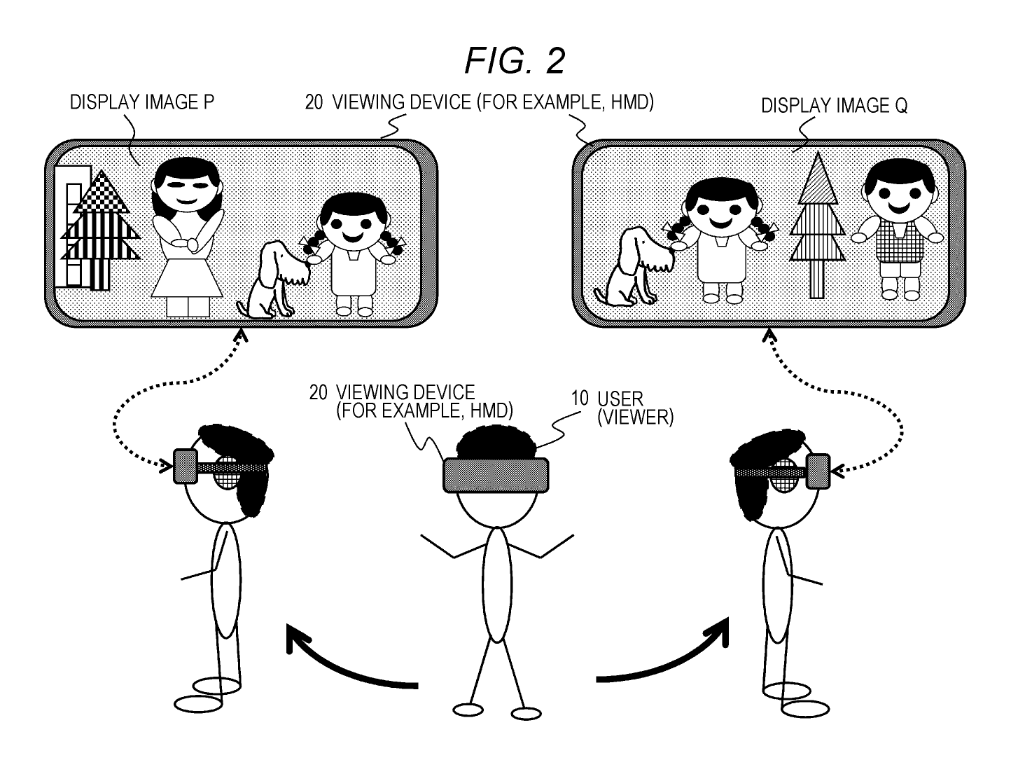

FIG. 2 is a diagram illustrating a user (viewer) wearing the viewing device 20 and an exemplary display image on the display of the viewing device 20.

An image in accordance with the motion and direction of a head mounted on the viewing device 20 is displayed on the display of the viewing device 20. This image is a rendered image by the PC 21.

Through this image display control, the user can enjoy feeling as if the user exists in an image displayed on a display unit of the viewing device 20.

A display image P is an image when the user (viewer) 10 wearing the viewing device 20 faces right.

A display image Q is an image when the user (viewer) 10 wearing the viewing device 20 faces left.

The user (viewer) 10 wearing the viewing device 20 can observe an image of 360 degrees by changing the orientation of the body (head).

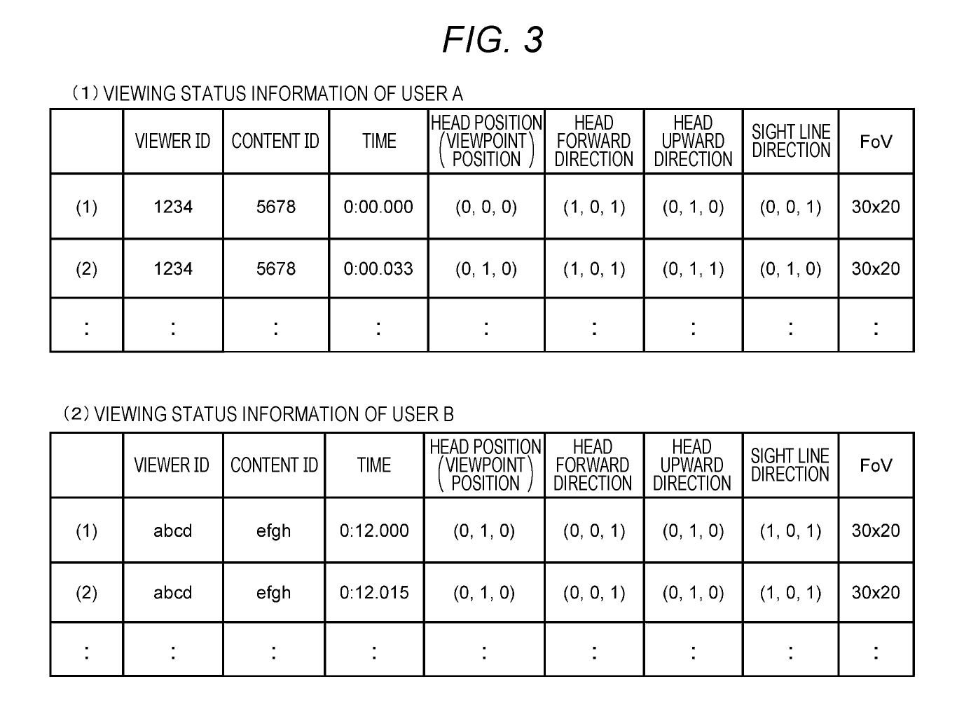

The following describes, with reference to FIG. 3, a detailed data configuration of the viewing status information 52 generated by the PC 21 connected with the viewing device 20 and transmitted to the viewing status information collection server 40.

As described above with reference to FIG. 1, information on the head position (viewpoint position) and the sight line direction of the user detected by a sensor mounted on the viewing device 20 is sequentially transmitted from the viewing device 20 to the PC 21.

The PC 21 records the head position (viewpoint position), the posture (head forward direction, head upward direction), the sight line direction, and the FoV of the user (viewer) 10 at each time in playback of the content 51, generates the viewing status information 52, and sequentially transmits the viewing status information 52 to the viewing status information collection server 40.

Data illustrated in FIG. 3 is exemplary data of the viewing status information 52 generated by the PC 21.

FIG. 3 illustrates exemplary data (1) and (2) of the viewing status information 52 of two users (viewers) A and B.

The viewing status information collection server 40 collects the viewing status information 52 of a large number of users through a network, and stores the viewing status information 52 in the viewing information record database 11.

As illustrated in FIG. 3, the viewing status information 52 records, for each time during playback of a content displayed on the display of the viewing device 20, a viewer ID, a content ID, a head position (viewpoint position), a head forward direction, a head upward direction, a sight line direction, and a FoV.

Note that, as described above, it is possible to use a sensor configured to detect the posture of the head simply by head tracking and determine the head forward direction as the sight line direction, and in this case, the head forward direction and the sight line direction align with each other.

Note that, in heat map generation processing as described later or the like, when the viewing status information includes “sight line direction” data, this data can be used as “sight line direction” data, and in a case where the viewing status information includes no “sight line direction” data, “head forward direction” can be used as “sight line direction” data.

The viewer ID is the identifier of a viewer, and provided for each user (viewer) viewing the content by, for example, the free viewpoint video distribution server 30 as the administrator of the content 51, or the manager or administrator of the viewing information collection server 40.

The content ID is the identifier of a content. The content ID is set to each provided content by, for example, the free viewpoint video distribution server 30 as the administrator of the content 51, or the manager or administrator of the viewing information collection server 40.

The free viewpoint video distribution server 30 and the content administrator as the manager of the viewing information collection server 40 hold a user list recording user IDs, and further hold a list recording the content ID of a content viewed by each user as viewing history information of the corresponding user ID.

The information of the head position (viewpoint position), the head forward direction, the head upward direction, the sight line direction, and the FoV is data that can be acquired or calculated by the PC 21 on the basis of, for example, sensor information input from the viewing device 20 mounted on the user (viewer) 10.

Head position (viewpoint position) data is made of xyz coordinates information indicating position information in an xyz three-dimensional space.

The direction information of the head forward direction, the head upward direction, and the sight line direction includes the xyz values of a directional vector (unit vector) indicating a direction in the xyz three-dimensional space.

The FoV is a view angle, in other words, a field of view (FoV) predetermined for the viewing device 20 as described above, and is constituted by the spreading angle of the upper surface of a viewing frustum set as a defined box of the FoV and the spreading angle information of a side surface.

In the example illustrated in FIG. 3, data [30×20] is recorded as the FoV, which indicates that the spreading angle of the upper surface of the viewing frustum set as the defined box of the FoV is 30°, and the spreading angle of the side surface is 20°.

The following describes, with reference to FIG. 4, data of the head position (viewpoint position), the head forward direction, the head upward direction, the sight line direction, and the FoV.

A coordinate system applied to the position direction information of the head position (viewpoint position), the head forward direction, the head upward direction, the sight line direction, and the FoV is a free viewpoint video content coordinate system set in advance to a free viewpoint video content displayed on the viewing device 20, which is illustrated on the lower-left side in FIG. 4.

However, these data are calculated by the PC 21 on the basis of sensor information of the viewing device 20.

In a case where the PC 21 outputs a free viewpoint video content and free viewpoint video content coordinate system information to the viewing device 20, and the viewing device 20 outputs, as sensor information, sensor information including position information and direction information in accordance with the free viewpoint video content coordinate system to the PC 21, the PC 21 can directly apply the sensor information and record the sensor information as the viewing status information illustrated in FIG. 3.

However, in a case where the viewing device 20 outputs position information and direction information as sensor information to which a unique coordinate system, for example, a viewer head coordinate system or the like with the head position of a user (viewer) wearing the viewing device 20 as a reference position (origin) is applied, the PC 21 converts the sensor information input from the viewing device 20 into the free viewpoint video content coordinate system as a coordinate system unique to a content, and records the sensor information to the viewing status information illustrated in FIG. 3.

FIG. 4 illustrates the data of the head position (viewpoint position), the head forward direction, the head upward direction, the sight line direction, and the FoV as data in accordance with the viewer head coordinate system.

As illustrated in FIG. 4, a central position P between the right and left eyeballs of the user (viewer) is set as the origin O of the viewer head coordinate system. The central position P between the right and left eyeballs is a head position P (=viewpoint position P).

The head forward direction is a Z-axis direction on the viewer head coordinate system, and the head upward direction is a Y-axis direction on the viewer head coordinate system.

The FoV (viewing frustum) illustrated in FIG. 4 corresponds to a view angle predetermined for the viewing device 20 mounted on the user (viewer) 10, and a content region in the range of the FoV (viewing frustum) is an image region corresponding to a viewing region of the user (viewer) 10.

The FoV (viewing frustum) is defined as a rectangular pyramid shaped box centered on the head forward direction (Z axis) of the user (viewer) 10.

The plane of the rectangular pyramid shaped FoV (viewing frustum) on a side closer to the user viewpoint is referred to as “Near clip”, and a plane thereof on a side farther from the user viewpoint is referred to as “Far clip”.

As described above, as FoV data in the viewing status information 52 illustrated in FIG. 3, “30×20”

the above-described data is recorded

The number “30” means that the spreading angle of a line (side) extending from “Near clip” to “Far clip” when the rectangular pyramid shaped FoV (viewing frustum) is viewed from top, from an origin P (head position. P (=viewpoint position P)) is 30 degrees.

The number “20” means that the spreading angle of the line (side) extending from “Near clip” to “Far clip” when the rectangular pyramid shaped FoV (viewing frustum) is viewed from side, from the origin P (head position P (=viewpoint position P)) is 20 degrees.

The example illustrated in FIG. 4 illustrates data of “head position (viewpoint position)”, “head forward direction”, “head upward direction”, and “sight line direction” in accordance with the viewer head coordinate system. In a case where sensor information input from the viewing device 20 mounted on the user (viewer) 10 is data in accordance with the viewer head coordinate system, the PC 21 converts the sensor information input from the viewing device 20 into the free viewpoint video content coordinate system as a content unique coordinate system, and records the converted data as the viewing status information 52 illustrated in FIG. 3.

The PC 21 generates the viewing status information 52 illustrated in FIG. 3, specifically, the viewing status information 52 recording the viewer ID, the content ID, the head position (viewpoint position), the head forward direction, the head upward direction, the sight line direction, and the FoV for each time during playback duration of a content displayed on the display of the viewing device 20, and sequentially transmits the viewing status information 52 to the viewing status information collection server 40.

The viewing status information collection server 40 collects the viewing status information 52 of a large number of users through a network, and stores the viewing status information 52 in the viewing information record database 41.

A server (information processing device) such as the viewing status information collection server 40 or the free viewpoint video distribution server 30 generates various kinds of analysis information by using the viewing status information 52 stored in the viewing information record database 41.

Specifically, for example, a heat map with which statistics information of the gaze point position corresponding to an attention region of a content and the viewpoint position (head position) of a user can be recognized is generated.

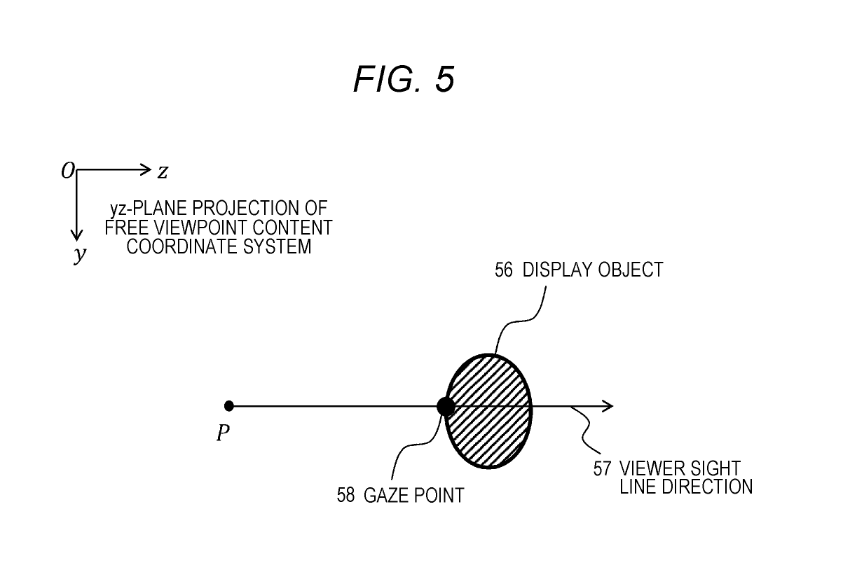

FIG. 5 is a diagram for description of exemplary processing of calculating a user gaze point, in other words, the gaze point of a user (viewer) on a free viewpoint video content, which can be acquired by using the viewing status information 52 stored in the viewing information record database 41.

As illustrated in FIG. 5, a gaze point 58 as a place gazed by the viewer can be determined from an intersection point between one display object 56 included in the free viewpoint video content and a viewer sight line direction 57.

Note that FIG. 5 illustrates plane projection data on a free viewpoint content coordinate system at a certain playback time, but in reality, a gaze point position in a three-dimensional coordinate system can be calculated from an intersection between a line segment and an object in a three-dimensional space.

Furthermore, although FIG. 5 illustrates an example in which one gaze point of one user (viewer) is calculated, a heat map illustrating the distribution status of the gaze points of a large number of users (viewers) can be generated by, for example, collecting gaze point information of a large number of viewing users at the same playback time of the same content.

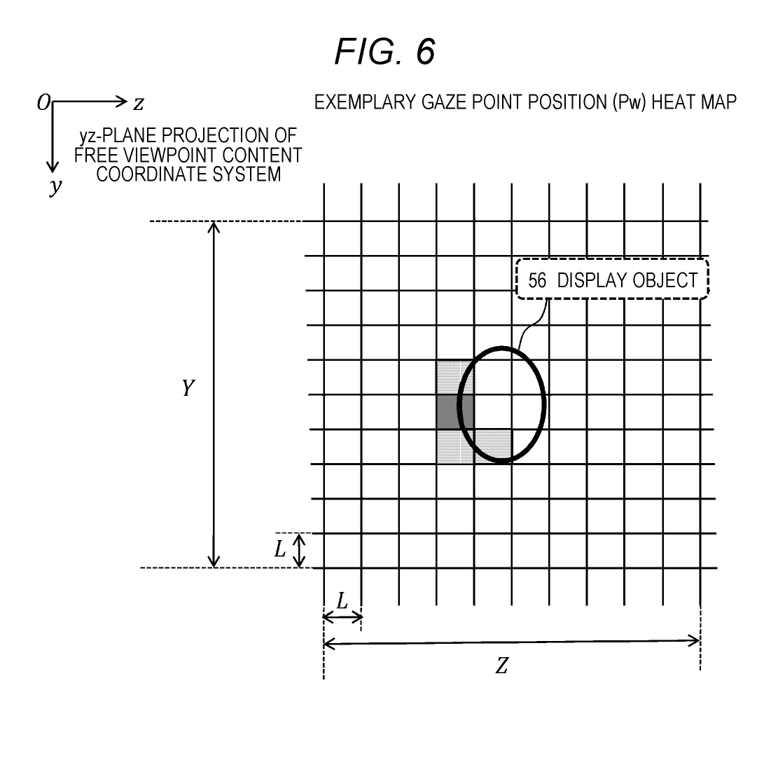

FIG. 6 is an exemplary heat map illustrating the distribution status of the gaze points of a large number of users (viewers), which is generated by using gaze point information of a large number of viewing users at the same playback time of the same content stored in the viewing information record database 41.

FIG. 6 illustrates a content display region centered on the one display object 56 included in the free viewpoint video content.

The example illustrated in FIG. 6 is a heat map illustrating the distribution status of the gaze points of a large number of users (viewers) in a playback frame at the same playback time of the same content stored in the viewing information record database 41.

A three-dimensional space corresponding to a video space included in one frame of the content is divided into lattices (for example, cubes of length L) each having a predetermined size, and each lattice is colored (in grayscale) in accordance with the number of gaze points included in the lattice.

For example, a lattice including a larger number of gaze points is set to a darker color (for example, black or dark red), and a lattice including a smaller number of gaze points is set to a lighter color (for example, light gray or pink). In a case where the number of gaze points included in a lattice is zero, white or transparent is set.

When each lattice is colored in accordance with the number of gaze points in this manner, a heat map that allows determination of the attention region of the content at a glance, in other words, a heat map in which the attention region is visualized can be generated.

Note that, for example, coloring processing of each lattice in a case where a heat map is displayed on the display can be achieved by changing an alpha channel value usable as set information of an output color in accordance with the number of gaze points to adjust an output color and an output concentration.

The following describes a specific example of lattice output value adjustment processing using the alpha channel.

For example, the alpha channel value of a lattice k is given by n(k)/N by using the number n(k) of gaze points included in the lattice k of a frame at time t, and the total number N of gaze points in the frame.

For example, in a case where the number of gaze points included in one lattice (=the number of users gazing at the lattice) is zero, the alpha channel value is 0.0, and the lattice output setting is transparent (=white).

Furthermore, in a case where the number of gaze points included in a lattice (=the number of users gazing at the lattice) is N, the alpha channel value is 1.0, and the lattice output setting is opaque (=black).

Note that, for understanding of description of each lattice output setting, the example in FIG. 6 illustrates a heat map as two-dimensional data, but in reality, a gaze point position in a three-dimensional coordinate system can be calculated from an intersection between a line segment and an object in a three-dimensional space, and a heat map can be generated and output as three-dimensional data.

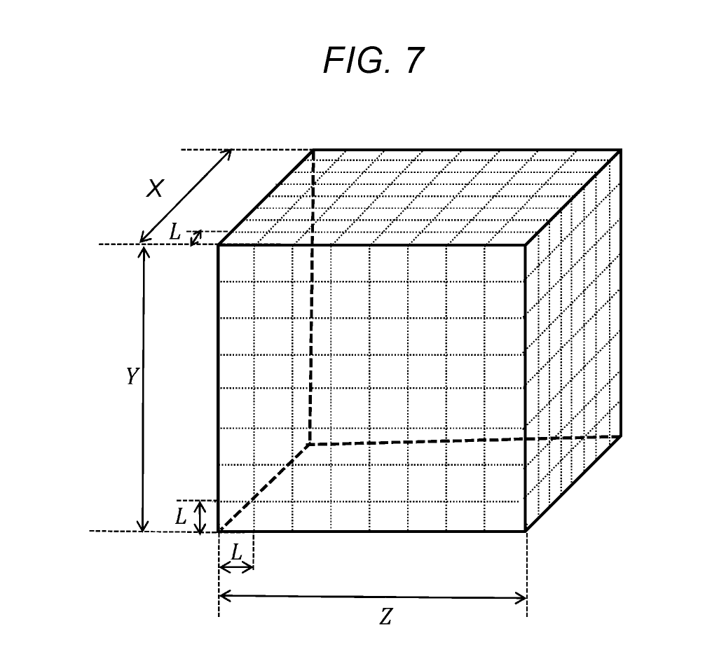

FIG. 7 illustrates exemplary lattice setting in a case where a heat map as three-dimensional data is generated.

As illustrated in FIG. 7, a lattice in which cubes each having sides of length L are arrayed is generated in the three-dimensional space of X×Y×Z.

The number of gaze points is counted for each of a large number of cubes of L×L×L disposed in this three-dimensional space, a lattice including a large number of gaze points is colored and output in a dark color or a color close to black, and a lattice including a small number of gaze points is colored and output in a light color or a color close to white.

In this manner, a heat map that allows recognition of an image region with a large number of gaze points at a glance can be generated and output as three-dimensional data as illustrated in FIG. 7 by using the gaze point information of a large number of viewing users at the same playback time of the same content stored in the viewing information record database 41.

The heat map described with reference to FIG. 6 is a heat map that illustrates a gaze point position indicating which part of the content a user (viewer) is watching, but a heat map of the head positions (viewpoint positions) of users (viewers) can be generated by using the record data of the viewing status information illustrated in FIG. 3.

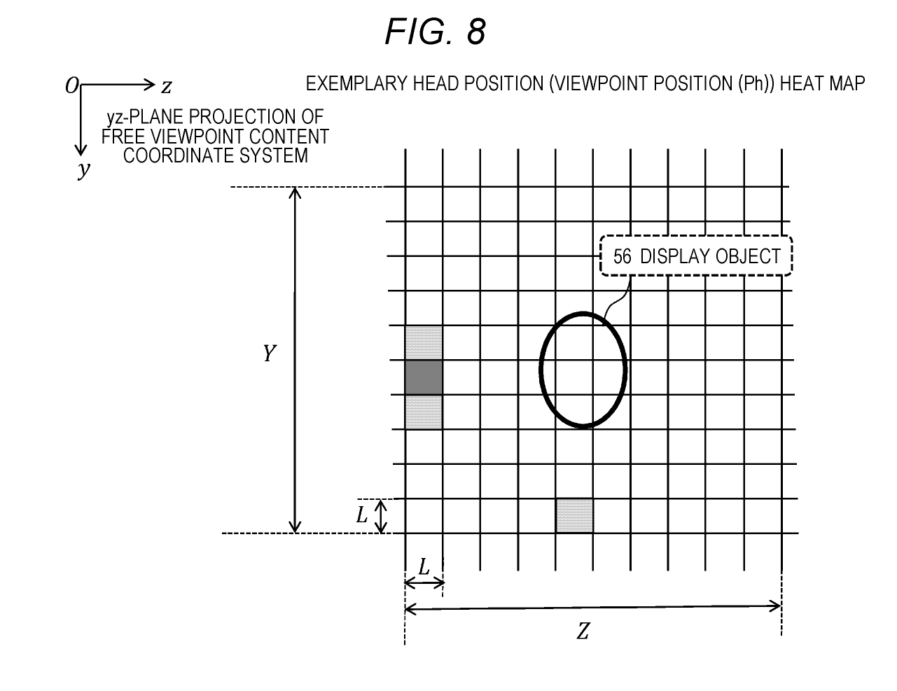

FIG. 8 illustrates an exemplary configuration of a heat map of the head positions (viewpoint positions) of users (viewers).

Similarly to FIG. 6 described above, FIG. 8 is an exemplary heat map illustrating the distribution status of the head positions (viewpoint positions) of a large number of users (viewers), which is generated by using the gaze point information of a large number of viewing users at the same playback time of the same content stored in the viewing information record database 41.

FIG. 8 illustrates a region centered on the one display object 56 included in the free viewpoint video content.

The example illustrated in FIG. 8 is a heat map that illustrates the distribution status of the head positions of a large number of users (viewers) in a playback frame at the same playback time of the same content stored in the viewing information record database 41.

The three-dimensional space is divided into lattices (for example, cubes of length L) each having a predetermined size, and each lattice is colored (in grayscale) in accordance with the number of head positions included in each lattice.

For example, a lattice including a larger number of head positions (viewpoint position) is set to a dark color (for example, black or dark red), and a lattice including a smaller number of head positions (viewpoint position) is set to a light color (for example, light gray or pink). In a case where the number of head positions (viewpoint positions) included in a lattice is zero, white or transparent is set.

In this manner, a heat map that allows determination of the head positions (viewpoint positions) of users viewing a content at a glance can be generated by coloring each lattice in accordance with the number of head positions (viewpoint positions).

Note that, for example, the coloring processing of each lattice in a case where a heat map is displayed on the display can be achieved by changing the alpha channel value usable as set information of an output color in accordance with the number of head positions (viewpoint positions) to adjust an output color and an output concentration.

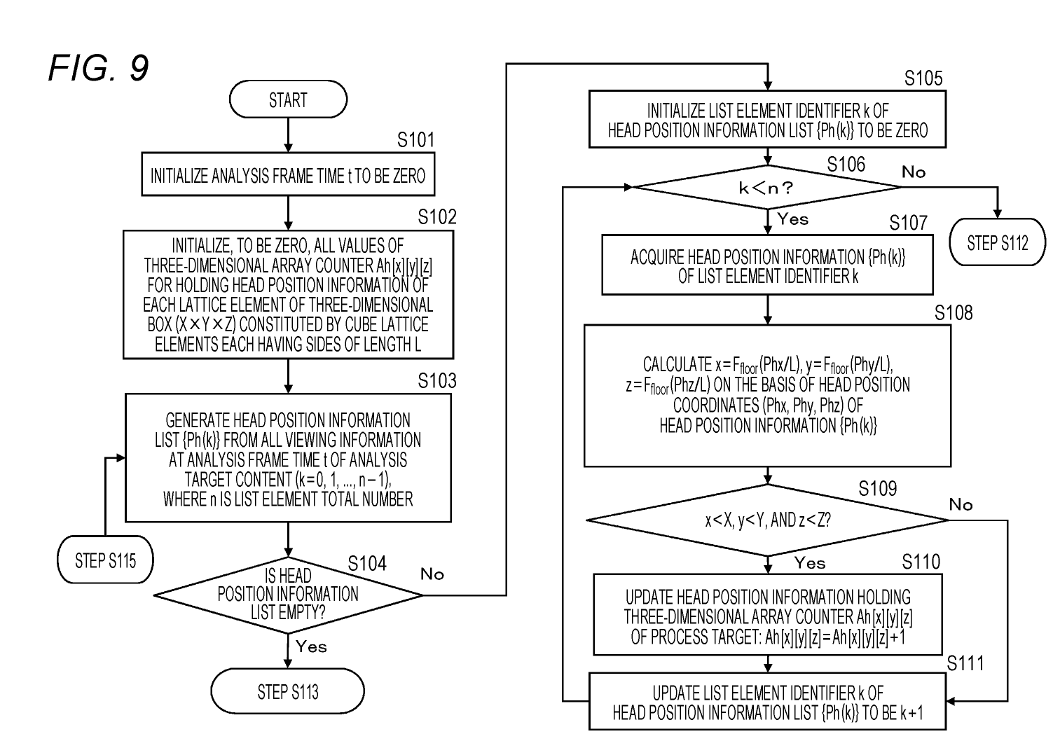

The following describes, with reference to flowcharts described in FIG. 9 and the following drawings, generation sequences of the gaze point position heat map described with reference to FIG. 6, and the head position (viewpoint position) heat map described with reference to FIG. 8.

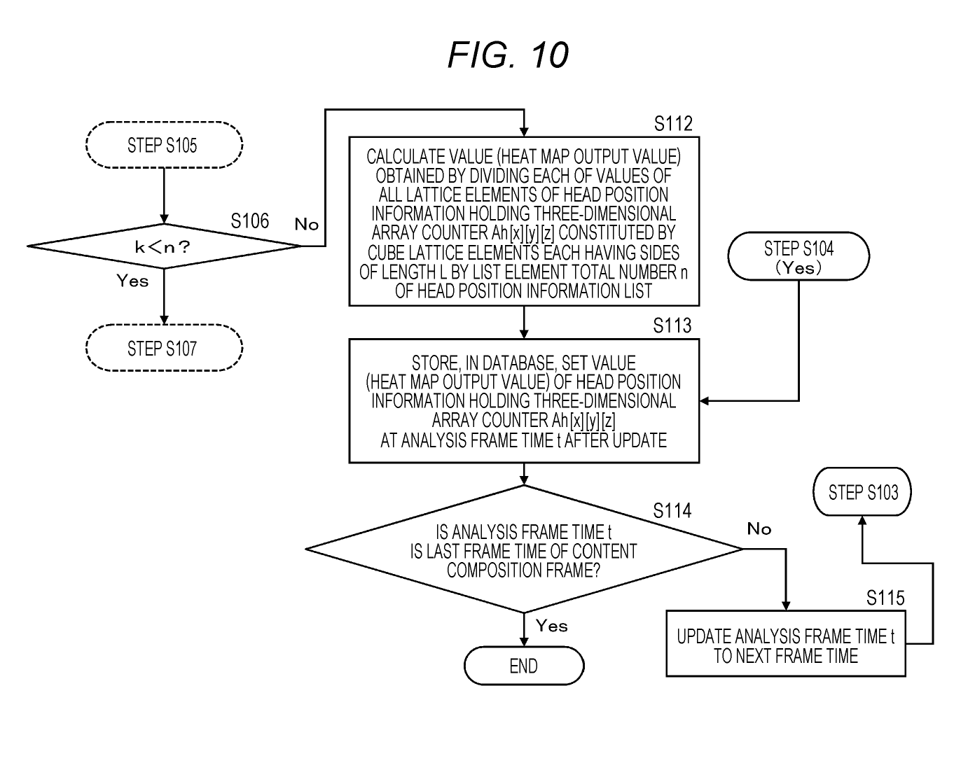

First, the generation sequence of the head position (viewpoint position) heat map described with reference to FIG. 8 will be described below with reference to flowcharts illustrated in FIGS. 9 and 10.

Note that the generation processing of the head position (viewpoint position) heat map in accordance with the flowcharts illustrated in FIGS. 9 and 10 can be executed by the information processing device of any of the free viewpoint video distribution server 30 and the viewing information collection server 40 illustrated in FIG. 1.

The information processing device such as the free viewpoint video distribution server 30 or the viewing information collection server 40 includes a data processing unit including a CPU having a computer program execution function, and executes processing in accordance with the flowcharts illustrated in FIGS. 9 and 10 under control of the data processing unit. Note that an exemplary hardware configuration of the information processing device will be described later.

The following describes processing at each step in the flowcharts illustrated in FIGS. 9 and 10.

(Step S101)

At step S101, the data processing unit of the information processing device performs initial setting of an analysis frame as a head position (viewpoint position) heat map generation processing target frame from a free viewpoint video content. Specifically, an analysis frame time: t=0 is set.

This corresponds to processing of selecting the first frame of the free viewpoint video content as the analysis target frame.

(Step S102)

Subsequently at step S102, the data processing unit of the information processing device executes initialization processing of setting zero to all values of a three-dimensional array counter Ah[x][y][z] for holding head position information for each lattice element of a three-dimensional box (X×Y×Z) constituted by cube lattice elements each having sides of length L.

The heat map has the three-dimensional configuration described with reference to FIG. 7.

As illustrated in FIG. 7, a three-dimensional box having a size of X×Y×Z and constituted by lattice elements of L×L×L is set.

L, X, Y, and Z are constants defined for each content. For example, L is defined to be 1 m, and X, Y, and Z are defined to be 10, and in this case, the entire three-dimensional space constituting the heat map is set to be 10 m×10 m×10 m, which means that 1000 lattice elements of 1 m×1 m×1 m are set therein.

Each lattice element of L×L×L can be identified by the coordinates information (x, y, z), and processing of counting the number of head positions (viewpoint positions) included in each lattice element specified by the coordinates information (x, y, z) is performed. A counter holding this count value is the head position information holding three-dimensional array counter Ah [x][y][z].

At step S102, initialization processing of setting zero to all the values of the counter Ah[x][y][z] of all lattice elements of L×L×L in the three-dimensional box having the size of X×Y×Z, which is illustrated in. FIG. 7 is executed.

(Step S103)

Subsequently at step S103, the data processing unit of the information processing device generates a head position information list {Ph(k)} from all viewing information of an analysis target content at the analysis frame time t. (k=0, 1, . . . , n−1, where n is the total number of list elements)

This processing is processing of acquiring only head position information from the viewing status information illustrated in FIG. 3 and generating a list made of the head position information only.

The viewing status information illustrated in FIG. 3 is acquired from a large number of users (viewers), and the information processing device acquires only the head position information from the acquired large number of lists, and generates the head position information list {Ph(k)} as a list made of the head position information only.

The number k is a list element identifier of 0, 1, . . . , n−1.

The number n is the total number of list elements, and corresponds to the number of users as content viewers on a viewing status list transmission side.

(Step S104)

Subsequently at step S104, the data processing unit of the information processing device determines whether or not the head position information list is empty.

In a case where the head position information list has no data (head position information), the process proceeds to step S113.

In a case where the head position information list has data (head position information), the process proceeds to step S105.

(Step S105)

Subsequently at step S105, the data processing unit of the information processing device initializes the list element identifier value k of the head position information list {Ph(k)} to be zero.

This processing is initialization processing of setting a processing target list element to be the first element of the head position information list {Ph(k)}.

(Step S106)

Subsequently at step S106, the data processing unit of the information processing device determines whether or not the list element identifier k satisfies a determination expression below:

k<n

In other words, it is determined whether or not the list element identifier k is smaller than the list element total number n.

In a case where the list element identifier k is equal to the list element total number n, it is meant that processing for all list elements of k=0 to n−1 is completed, and in this case, the process proceeds to step S112.

On the other hand, in a case where the list element identifier k is less than the list element total number n, it is meant that processing for all list elements of k=0 to n−1 is not completed and there is any unprocessed list element, and in this case, the process proceeds to step S107.

(Step S107)

Subsequently at step S107, the data processing unit of the information processing device acquires the head position information {Ph(k)} of the list element identifier k.

This head position information is obtained as coordinates information (Phx, Phy, Phz) in accordance with the free viewpoint video content coordinate system as described above with reference to FIG. 3 and other drawings.

(Step S108)

Subsequently at step S108, the data processing unit of the information processing device calculates the values x, y, and z in accordance with Equation 1 below on the basis of the head position coordinates (Phx, Phy, Phz) of the head position information {Ph(k)}.

x=F_{floor}(Phx/L),

y=F_{floor}(Phy/L),

z=F_{floor}(Phz/L), (Equation 1)

Note that, F_{floor}(a) is a function that returns the integer part of a.

The above Equation 1 is a formula for calculating a lattice element in which the position of the coordinates information (Phx, Phy, Phz) as the head position information {Ph(k)} of the list element identifier k is included among a large number of lattice elements of L×L×L, set in the box of X×Y×Z illustrated in FIG. 7.

For example, in a case where the calculation result of x=y=z=0 is obtained by the above Equation 1, it is meant that the lattice element in which the head position coordinates (Phx, Phy, Phz) of the head position information {Ph(k)} are included is one lattice element in contact with the origin in the box of X×Y×Z illustrated in FIG. 7.

Furthermore, for example, in a case where the calculation result of x=5 and y=z=0 is obtained by the above Equation 1, it is meant that the lattice element in which the head position coordinates (Phx, Phy, Phz) of the head position information {Ph(k)} is included is the sixth lattice element from the origin along the X axis in the box of X×Y×Z, illustrated in FIG. 7.

At step S108, in this manner, it is calculated which lattice element in the three-dimensional box constituting the hit map the head position coordinates (Phx, Phy, Phz) of the head position information {Ph(k)} are included in.

The coordinates (x, y, z) calculated by the above Equation 1 is the position information (identifier) of the lattice element in which the head position coordinates (Phx, Phy, Phz) of the head position information {Ph(k)} are included.

(Step S109)

Subsequently at step S109, the data processing unit of the information processing device determines whether or not (x, y, z) calculated in accordance with the above Equation 1 at step S108, in other words, (x, y, z) as the position information (identifier) of the lattice element in which the head position coordinates (Phx, Phy, Phz) of the head position information {Ph(k)} are included satisfies Equation 2 below.

0≤x<X, 0≤y<Y, and 0≤z<Z (Equation 2)

X, Y, and Z are the lengths of sides of a three-dimensional box that defines the heat map illustrated in FIG. 7.

In a case where the above Equation 2 is satisfied, the position (x, y, z) as the position information (identifier) of the lattice element in which the head position coordinates (Phx, Phy, Phz) are included is inside the three-dimensional box that defines the heat map illustrated in FIG. 7.

However, in a case where the above Equation 2 is not satisfied, the position (x, y, z) as the position information (identifier) of the lattice element in which the head position coordinates (Phx, Phy, Phz) are included is out of the three-dimensional box that defines the heat map illustrated in FIG. 7.

In this case, processing of increasing the lattice element counter value (=head position number) of the heat map cannot be performed.

Thus, in this case, counter value update processing at step S110 is omitted, and the process proceeds to step S111.

(Step S110)

Processing at step S110 is processing performed in a case where it is determined at step S109 that (x, y, z) as the position information (identifier) of the lattice element in which the head position coordinates (Phx, Phy, Phz) of the head position information {Ph(k)} are included satisfies Equation 2 below.

0≤x<X, 0≤y<Y, and 0≤z<Z (Equation 2)

In a case where the above Equation 2 is satisfied, the position (x, y, z) as the position information (identifier) of the lattice element in which the head position coordinates (Phx, Phy, Phz) are included is inside the three-dimensional box that defines the heat map illustrated in FIG. 7.

In this case, at step S110, the data processing unit of the information processing device executes processing of increasing the counter value by one as update processing of the head position information holding three-dimensional array counter Ah[x][y][z] as a processing target. In other words, counter value update processing as follows is performed.

Ah[x][y][z]=Ah[x][y][z]+1

Through this counter value update processing, the count value of the counter Ah[x][y][z]of (x, y, z) as a lattice element to which the head position calculated at step S108 belongs is increased by one, and updated to count data set such that the head position of one user (viewer) is included in this lattice element.

(Step S111)

Subsequently at step S111, the data processing unit of the information processing device executes processing of updating a processing target list element from the head position information list {Ph(k)}.

In other words, update processing is performed to set the list element identifier k to be:

k=k+1

Through this processing, the processing target element of the head position information list {Ph(k)} is set to be the next element.

After the list element update processing at step S111, processing starting at step S106 is executed on the list element k set as the new processing target.

In a case where, at step S106, the determination expression below does not hold:

k<n

and it is determined that processing of all n list elements registered to the head position information list is completed, the process proceeds to step S112.

(Step S112)

When it is determined that processing of all n list elements registered to the head position information list is completed, the data processing unit of the information processing device calculates, at step S112, a value (heat map output value) obtained by dividing each of the values of all lattice elements of the head position information holding three-dimensional array counter Ah[x][y][z] constituted by cube lattice elements each having sides of length L by the list element total number n.

Through the division processing, the set value of the head position information holding three-dimensional array counter Ah[x][y][z] corresponding to each lattice element is set to be a value in the range of 0 to 1.

The number of head positions included in one lattice element is n at maximum, and the set value of the three-dimensional array counter Ah[x][y][z] is set to be a value in the range of 0 to 1 through the division processing by n.

(Step S113)

Subsequently at step S113, the data processing unit of the information processing device stores, in a database, the set value (heat map output value) of the head position information holding three-dimensional array counter Ah[x][y][z] at the analysis frame time t after update.

Furthermore, output processing is executed, for example, in response to an output request from a user.

Note that, as described above, the coloring processing of each lattice in a case where, for example, the heat map is displayed on the display adjusts the output color and the output concentration by changing the alpha channel value usable as output color set information in accordance with the set value of the three-dimensional array counter Ah[x][y][z].

Through this processing, a lattice element including a large number of head positions is output in a dark color, and a lattice element including a small number of head positions is output in a light color, which allows determination of the distribution of head positions at a glance.

(Step S114)

Subsequently at step S114, the data processing unit of the information processing device determines whether or not the analysis frame time t is the last frame time of the content composition frame.

In a case where the analysis frame time t is the last frame time of the content composition frame, it is determined that processing of all frames is completed, and the process ends.

On the other hand, in a case where the analysis frame time t is not the last frame time of the content composition frame, it is determined that there is any unprocessed frame, and the process proceeds to step S115.

(Step S115)

In a case where it is determined at step S114 that there is any unprocessed frame, the data processing unit of the information processing device executes update processing of the frame time of the analysis target frame at step S115.

Specifically, the frame time t of the analysis target frame is updated to the next frame time.

After this update processing, the process returns to step S103, and the processing starting at step S103 is executed on the unprocessed frame.

In a case where it is determined at step S114 that there is no unprocessed frame, the head position heat map corresponding to all composition frames of the content is completed, and the process ends.

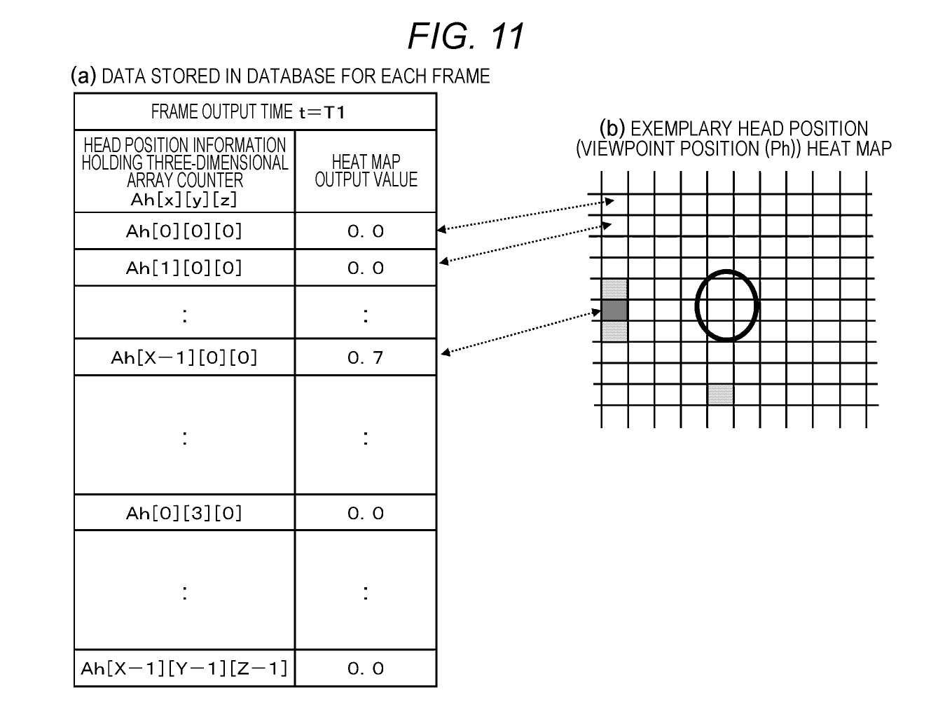

When the processing in accordance with the flowcharts illustrated in FIGS. 9 and 10 is executed, data as illustrated in FIG. 11(a) is stored as frame unit data in a database, and a head position (viewpoint position) heat map as illustrated in FIG. 11(b) can be output by using this data.

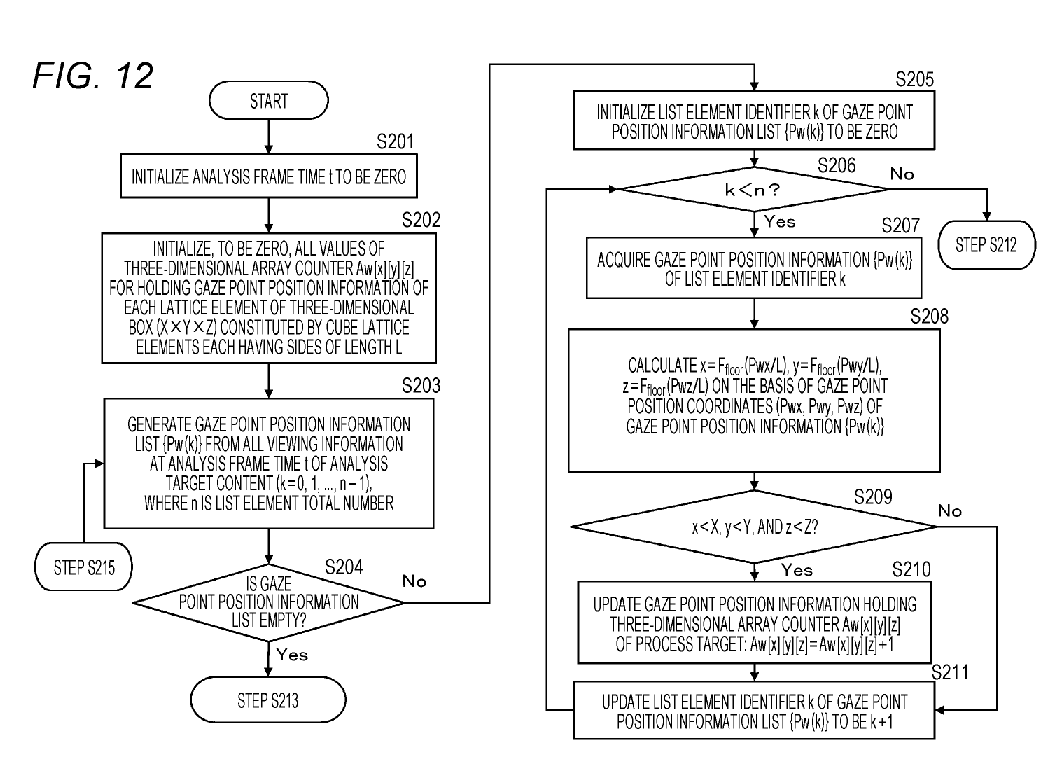

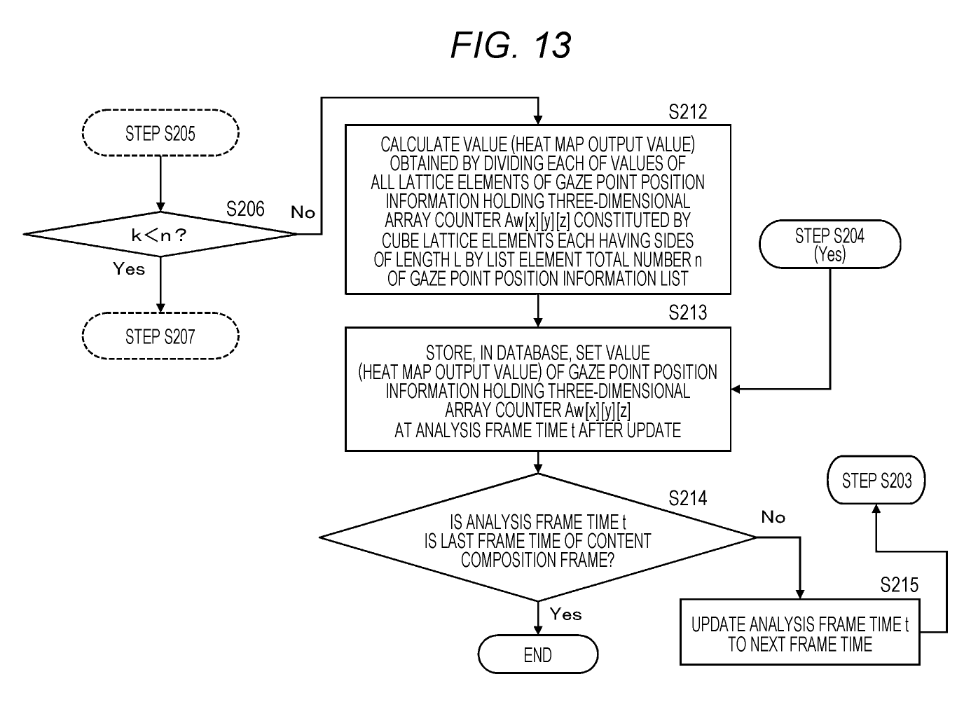

The generation sequence of the gaze point position heat map described with reference to FIG. 6 will be described below with reference to flowcharts illustrated in FIGS. 12 and 13.

Note that the generation processing of the gaze point position heat map in accordance with the flowcharts illustrated in FIGS. 12 and 13 can be executed by the information processing device of any of the free viewpoint video distribution server 30 and the viewing information collection server 40 illustrated in FIG. 1.

The information processing device such as the free viewpoint video distribution server 30 or the viewing information collection server 40 includes a data processing unit including a CPU having a computer program execution function, and executes processing in accordance with the flowcharts illustrated in FIGS. 12 and 13 under control of the data processing unit. Note that an exemplary hardware configuration of the information processing device will be described later.

The following describes processing at each step in the flowcharts illustrated in FIGS. 12 and 13.

(Step S201)

At step S201, the data processing unit of the information processing device performs initial setting of an analysis frame as a target frame of the generation processing of the gaze point position heat map, from the free viewpoint video content. Specifically, an analysis frame time: t=0 is set.

This corresponds to processing of selecting the first frame of the free viewpoint video content as the analysis target frame.

(Step S202)

Subsequently at step S202, the data processing unit of the information processing device executes initialization processing of setting zero to all values of a three-dimensional array counter Aw[x][y][z] for holding gaze point position information for each lattice element of a three-dimensional box (X×Y×Z) constituted by cube lattice elements each having sides of length L.

The heat map has the three-dimensional configuration described with reference to FIG. 7.

As illustrated in FIG. 7, a three-dimensional box having a size of X×Y×Z and constituted by lattice elements of L×L×L is set.

L, X, Y, and Z are constants defined for each content. For example, L is defined to be 1 m, and X, Y, and Z are defined to be 10, and in this case, the entire three-dimensional space constituting the heat map is set to be 10 m×10 m×10 m, which means that 1000 lattice elements of 1 m×1 m×1 m are set therein.

Each lattice element of L×L×L can be identified by the coordinates information (x, y, z), and processing of counting the number of gaze point positions included in each lattice element specified by the coordinates information (x, y, z) is performed. A counter holding this count value is the gaze point position information holding three-dimensional array counter Aw[x][y][z].

At step S202, initialization processing of setting zero to all the values of the counter Aw[x][y][z] of all lattice elements of L×L×L in the three-dimensional box having the size of X×Y×Z, which is illustrated in FIG. 7 is executed.

(Step S203)

Subsequently at step S203, the data processing unit of the information processing device generates a gaze point position information list {Pw(k)} from all viewing information of an analysis target content at the analysis frame time t. (k=0, 1, . . . , n−1, where n is the total number of list elements)

This processing is processing of generating a list made of the gaze point position information only on the basis of the data of the viewing status information illustrated in FIG. 3.

The viewing status information illustrated in FIG. 3 is acquired from a large number of users (viewers), and the information processing device generates the gaze point position information list {Pw(k)}as the list made of the gaze point position information only on the basis of the data of a large number of acquired lists.

The number k is a list element identifier of 0, 1, . . . , n−1.

n is the list element total number.

Note that the gaze point positron calculation processing based on the data of the viewing status information illustrated in FIG. 3 is executed in accordance with the processing described above with reference to FIG. 5.

Specifically, a sight line (half line) is calculated from the head position coordinates and the sight line direction included in the viewing status information. Furthermore, an intersection point between the sight line (half line) and each object included in the free viewpoint video content is calculated.

An intersection point closest to the head position among these intersection points, which is included in the viewing frustum expressed by the FoV, the near clip, and the far clip is selected.

As a result, the coordinate data of the selected intersection point position is added to the gaze point position information list {Pw(k)}.

Note that, in a case where there is no intersection point with an object or no intersection point is included in the viewing frustum, it is determined that there is no gaze point, and nothing is added to the list.

The processing of determining a gaze point from the viewing status information and adding the gaze point to the list in this manner is repeatedly executed for all viewing status information to generate the gaze point position information list {Pw(k)} as a list made of the gaze point position information only.

(Step S204)

Subsequently at step S204, the data processing unit of the information processing device determines whether or not the gaze point position information list is empty.

In a case where the gaze point position information list has no data (gaze point position information), the process proceeds to step S213.

In a case where the gaze point position information list has data (the gaze point position information), the process proceeds to step S205.

(Step S205)

Subsequently at step S205, the data processing unit of the information processing device initializes the list element identifier value k of the gaze point position information list {Pw(k)} to be zero.

This processing is initialization processing of setting the first element to be a processing target list element of the gaze point position information list {Pw(k)}.

(Step S206)

Subsequently at step S206, the data processing unit of the information processing device determines whether or not the list element identifier k satisfies a determination expression below:

k<n

In other words, it is determined whether or not the list element identifier k is smaller than the list element total number n.

In a case where the list element identifier k is equal to the list element total number n, it is meant that processing for all list elements of k=0 to n−1 is completed, and in this case, the process proceeds to step S212.

On the other hand, in a case where the list element identifier k is less than the list element total number n, it is meant that processing for all list elements of k=0 to n−1 is not completed and there is any unprocessed list element, and in this case, the process proceeds to step S207.

(Step S207)

Subsequently at step S207, the data processing unit of the information processing device acquires the gaze point position information {Pw(k)} of the list element identifier k.

The gaze point position information can be obtained as coordinates information (Pwx, Pwy, Pwz) in accordance with the free viewpoint video content coordinate system as described above with reference to FIG. 3 and other drawings.

(Step S208)

Subsequently at step S208, the data processing unit of the information processing device calculates the values x, y, and z in accordance with Equation 3 below on the basis of the gaze point position coordinates (Pwx, Pwy, Pwz) of the gaze point position information {Pw(k)}.

x=F_{floor}(Pwx/L),

y=F_{floor}(Pwy/L),

z=F_{floor}(Pwz/L), (Equation 3)

Note that, F_{floor}(a) is a function that returns the integer part of a.

The above Equation 1 is a formula for calculating a lattice element in which the position of the coordinates information (Pwx, Pwy, Pwz) as the gaze point position information. {Pw(k)} of the list element identifier k is included among a large number of lattice elements of L×L×L set in the box of X×Y×Z illustrated in FIG. 7.

In a case where, for example, the calculation result of x=y=z=5 is obtained by the above Equation 3, it is meant that the lattice element in which the gaze point position coordinates (Pwx, Pwy, Pwz) of the gaze point position information {Pw(k)} are included is one lattice element that is sixth from the origin in the box of X×Y×Z illustrated in FIG. 7 along the X axis, sixth from the origin along the Y axis, and sixth from the origin along the Z axis.

At step S208, the lattice element in which the gaze point position coordinates (Pwx, Pwy, Pwz) of the gaze point position information {Pw(k)} are included in the three-dimensional box constituting the hit map is calculated in this manner.

(x, y, z) calculated by the above Equation 1 is the position information (identifier) of the lattice element in which the gaze point position coordinates (Pwx, Pwy, Pwz) of the gaze point position information {Pw(k)} are included.

(Step S209)

Subsequently at step S209, the data processing unit of the information processing device determines whether or not (x, y, z) calculated in accordance with the above Equation 3 at step S208, in other words, (x, y, z) as the position information (identifier) of the lattice element in which the gaze point position coordinates (Pwx, Pwy, Pwz) of the gaze point position information {Pw(k)} are included satisfies Equation 4 below.

0≤x<X, 0≤y<Y, and 0≤z<Z (Equation 4)

X, Y, and Z are the lengths of sides of a three-dimensional box that defines the heat map illustrated in FIG. 7.

In a case where the above Equation 4 is satisfied, the position of (x, y, z) as the position information (identifier) of the lattice element in which the gaze point position coordinates (Pwx, Pwy, Pwz) are included is inside the three-dimensional box that defines the heat map illustrated in FIG. 7.

However, in a case where the above Equation 4 is not satisfied, the position of (x, y, z) as the position information (identifier) of the lattice element in which the gaze point position coordinates (Pwx, Pwy, Pwz) are included is out of the three-dimensional box that defines the heat map illustrated in FIG. 7.

In this case, processing of increasing the heat map lattice element counter value (=gaze point, position number) cannot be performed.

Thus, in this case, counter value update processing at step S210 is omitted, and the process proceeds to step S211.

(Step S210)

Processing at step S210 is processing performed in a case where it is determined at step S209 that (x, y, z) as the position information (identifier) of the lattice element in which the gaze point position coordinates (Pwx, Pwy, Pwz) of the gaze point position information {Pw(k)}are included satisfies Equation 4 below.

0≤x<X, 0≤y<Y, and 0≤z<Z (Equation 4)

In a case where the above Equation 4 is satisfied, the position of (x, y, z) as the position information (identifier) of the lattice element in which the gaze point position coordinates (Pwx, Pwy, Pwz) are included is inside the three-dimensional box that defines the heat map illustrated in FIG. 7.

In this case, the data processing unit of the information processing device executes, at step S210, processing of increasing the counter value by one as update processing of the gaze point position information holding three-dimensional array counter Aw[x][y][z] as a processing target. In other words, counter value update processing as follows is performed.

Aw[x][y][z]=Aw[x][y][z]+1

Through this counter value update processing, the count value of the counter Aw[x][y][z] of (x, y, z) as a lattice element to which the gaze point position calculated at step S208 belongs is increased by one and updated to count data set such that the gaze point position of one user (viewer) is included in the lattice element.

(Step S211)

Subsequently at step S211, the data processing unit of the information processing device executes processing of updating a processing target list element from the gaze point position information list {Pw(k)}.

In other words, update processing is performed to set the list element identifier k to be:

k=k+1

Through this processing, the processing target element of the gaze point position information list {Pw(k)} is set to be the next element.

After the list element update processing at step S211, processing starting at step S206 is executed on the list element k set as the new processing target.

At step S206, in a case where the determination expression below does not hold:

k<n

and it is determined that processing of all n list elements registered to the gaze point position information list is completed, the process proceeds to step S212.

(Step S212)

When it is determined that the processing of all n list elements registered to the gaze point position information list is completed, the data processing unit of the information processing device calculates, at step S212, a value (heat map output value) obtained by dividing, by the list element total number n, the value of each of all lattice elements of the gaze point position information holding three-dimensional array counter Aw[x][y][z] made of cube lattice elements each having sides of length L.

Through the division processing, the set value of the gaze point position information holding three-dimensional array counter Aw[x][y][z] corresponding to each lattice element is set to be a value in the range of 0 to 1.

The number of gaze point positions included in one lattice element is n at maximum, and the set value of the three-dimensional array counter Aw[x][y][z] is set to be a value in the range of 0 to 1 through the division processing by n.

(Step S213)

Subsequently at step S213, the data processing unit of the information processing device stores, in a database, the set value (heat map output value) of the gaze point position information holding three-dimensional array counter Aw[x][y][z] at the analysis frame time t after update.

Furthermore, output processing is executed, for example, in response to an output request from a user.

Note that, as described above, the coloring processing of each lattice in a case where, for example, the heat map is displayed on the display adjusts the output color and the output concentration by changing the alpha channel value usable as output color set information in accordance with the set value of the three-dimensional array counter Aw[x][y][z].

Through this processing, a lattice element including a large number of gaze point positions is output in a dark color, and a lattice element including a small number of gaze point positions is output in a light color, which allows determination of the distribution of gaze point positions at a glance.

(Step S214)

Subsequently at step S214, the data processing unit of the information processing device determines whether or not the analysis frame time t is the last frame time of the content composition frame.

In a case where the analysis frame time t is the last frame time of the content composition frame, it is determined that processing of all frames is completed, and the process ends.

On the other hand, in a case where the analysis frame time t is not the last frame time of the content composition frame, it is determined that there is any unprocessed frame, and the process proceeds to step S215.

(Step S215)

In a case where it is determined at step S214 that there is any unprocessed frame, the data processing unit of the information processing device executes update processing of the frame time of the analysis target frame at step S215.

Specifically, the frame time t of the analysis target frame is updated to the next frame time.

After this update processing, the process returns to step S203, and the processing starting at step S203 is executed on the unprocessed frame.

In a case where it is determined at step S219 that there is no unprocessed frame, the gaze point position heat map corresponding to all composition frames of the content is completed, and the process ends.

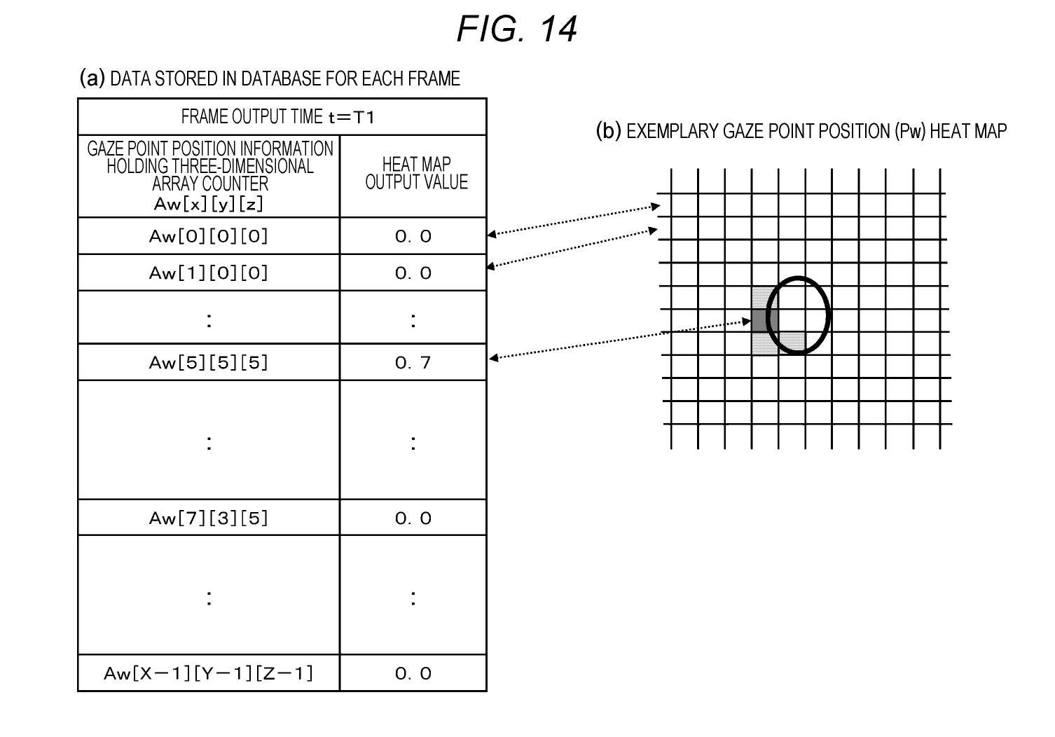

When the processing in accordance with the flowcharts illustrated in FIGS. 12 and 13 is executed, data as illustrated in FIG. 14(a) is stored as frame unit data in a database, and a heat map as illustrated in FIG. 14(b) can be output by using this data.

[2-(b). Embodiment of Provision of Recommended Viewpoint Information and Execution of Display Control Based on Recommended Viewpoint Information]

The following describes an embodiment in which provision of recommended viewpoint information and display control based on the recommended viewpoint information are executed.

The embodiment described below is an embodiment in which a content in an image region at a most popular viewpoint position in a sight line direction at each time is automatically displayed on the basis of a viewing status analysis result.

Through this content control, video watched by a large number of viewers can be preferentially provided.

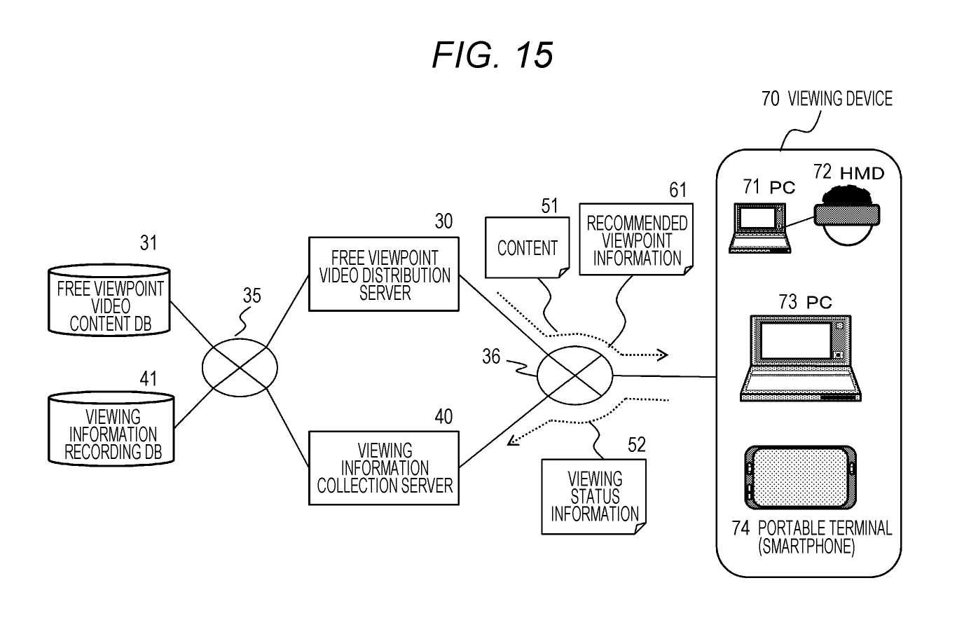

FIG. 15 is a diagram illustrating an exemplary configuration of an information processing system in which the provision of recommended viewpoint information and display control based on the recommended viewpoint information are executed.

Similarly to the information processing system described above with reference to FIG. 1, the free viewpoint video distribution server 30 acquires, through the network 35, a free viewpoint video content stored in the free viewpoint video content database 31, and transmits the acquired free viewpoint video content to the information processing device (content output device) 70 on the user (viewer) side through the network 36.

FIG. 15 illustrates, as exemplary viewing devices 70, a PC 73 and a portable terminal (smartphone) 74 in addition to a combination of a PC 71 and a HMD 72 configured to display an image rendered by the PC 71 as described with reference to FIG. 1.

With the PC 73 or the portable terminal (smartphone) 74 other than the HMD 72, the user (viewer) can freely change an image region displayed on the viewing device.

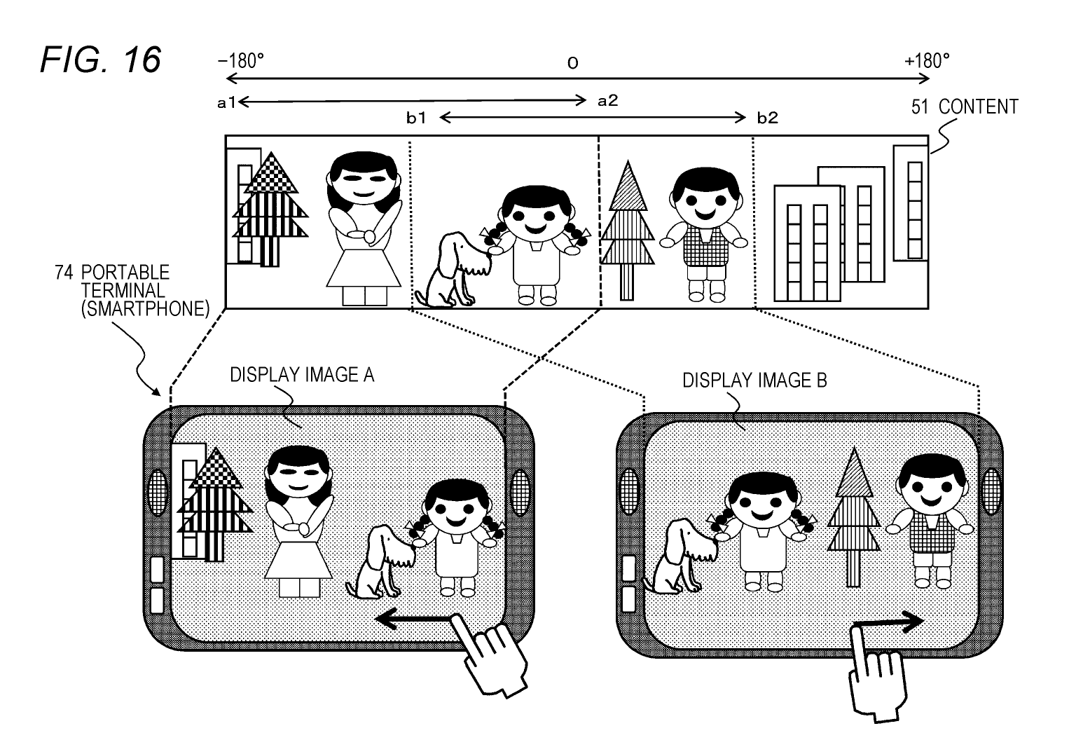

The following describes exemplary change of the display image region with reference to FIG. 16.

The upper part of FIG. 16 illustrates the content 51 as a free viewpoint video content, and the lower part of FIG. 16 illustrates the portable terminal (smartphone) 74.

A display unit of the portable terminal (smartphone) 74 can display an image of a partial region of the free viewpoint video content, for example, a region optionally selected by the user.

Display image A of the portable terminal (smartphone) 74 on the left side is a region image of a partial interval in the image interval of a1 to a2 of a partial region in the content 51.

Display image B of the portable terminal (smartphone) 74 on the right side is a region image of a partial interval in the image interval of b1 to b2 of a partial region in the content 51.

The user can move the display image to display an image of an optional region through, for example, finger slide processing on the display unit configured as a touch panel.

In a case where a display device such as a PC or a television is used, too, the display region can be freely selected through an input operation of a keyboard, a mouse, a remote controller, or the like.

The system configuration description continues with reference to FIG. 15.

Similarly to the processing described above with reference to FIG. 1 and the following drawings, the viewing device 70 transmits the viewing status information. 52 having the data configuration illustrated in FIG. 3 to the viewing information collection server 40.

The viewing information collection server 40 stores the collected viewing status information in the viewing information record database 41 connected through the network 35.

The information processing system illustrated in FIG. 15 is different from the system illustrated in FIG. 1 in that the free viewpoint video distribution server 30 transmits recommended viewpoint information 61 to the viewer device 70.

In the present embodiment, the free viewpoint video distribution server 30 analyzes the viewing status information stored in the viewing information record database 41, generates the recommended viewpoint information 61 on the basis of a result of the analysis, and transmits the recommended viewpoint information 61 to the viewer device 70.

The viewer device 70 can perform, by using the recommended viewpoint information 61, for example, display control to automatically display a content in an image region at a most popular viewpoint position in a sight line direction at each content playback time. Through this content display control, a high image or the like of a large number of viewers can be preferentially provided.

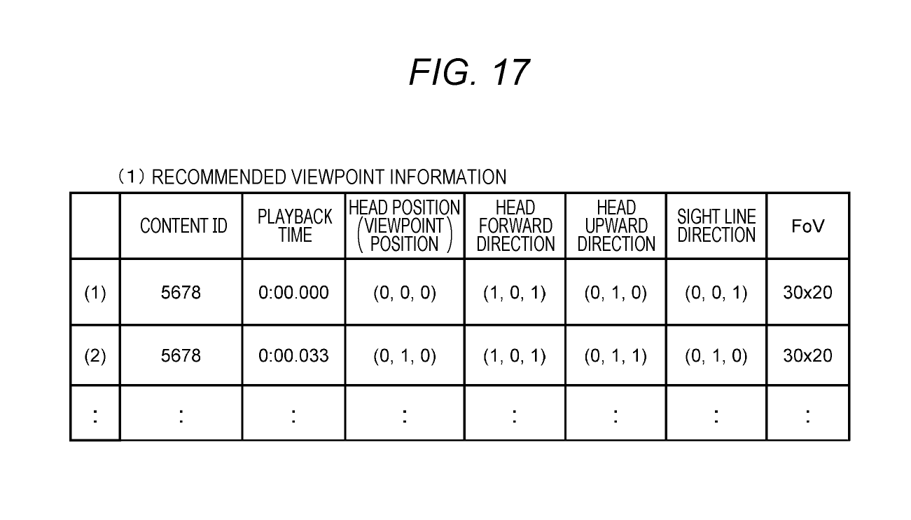

The following describes, with reference to FIG. 17, an exemplary data configuration of the recommended viewpoint information 61 generated on the basis of the viewing status information stored in the viewing information record database 41 and transmitted to the viewer device 70 by the free viewpoint video distribution server 30.

As illustrated in FIG. 17, the recommended viewpoint information 61 records a content ID, a playback time, a head position, a head forward direction, a head upward direction, a sight line direction, and a FoV.

This data is data recording, for a content specified by the content ID, a head position (viewpoint position), a head forward direction, a head upward direction, a sight line direction, and a FoV recommended at each playback time.

In other words, a recommended image or a most popular image can be automatically displayed by displaying the image with settings of the head position (viewpoint position), the head forward direction, the head upward direction, the sight line direction, and the FoV recorded in the recommended viewpoint information illustrated in FIG. 17.

Note that, in a case where a recommended image in accordance with the recommended viewpoint information 61 is automatically displayed on the display in the viewing device 70, the mode of the viewing device 70 needs to be set to an automatic viewpoint control mode.

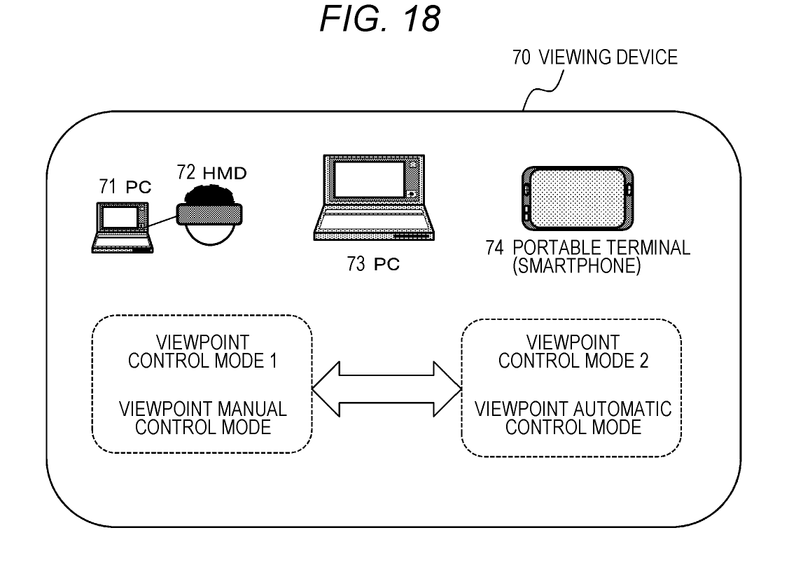

As illustrated in FIG. 18, the viewing device 70 has such a configuration to achieve switching between the following two viewpoint control modes that can be set in the content display processing.

(1) Viewpoint control mode 1=Manual viewpoint control mode

(2) Viewpoint control mode 2=Automatic viewpoint control mode

The manual viewpoint, control mode is a mode in which the display region can be changed by intention of the user, and in a case of a HMD, a mode in which the position and direction of the head of the user (viewer) are changed to change the display image in accordance with the change aspect.

Furthermore, in a case where the content is displayed on the display of a PC, a smartphone, or the like, the display image region can be moved through input processing on a touch panel, a mouse, or the like by the user.

On the other hand, the automatic viewpoint control mode is a mode in which a recommended image in accordance with the recommended viewpoint information 61 is automatically displayed on the display.

In setting of the automatic viewpoint control mode, the change processing of the display image in accordance with motion of a HMD or user input on a PC, a smartphone, or the like is stopped.

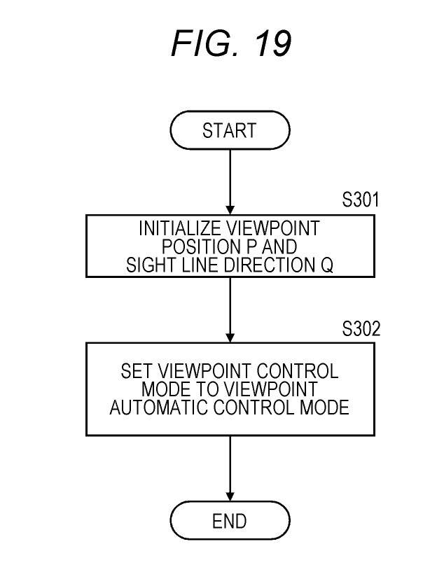

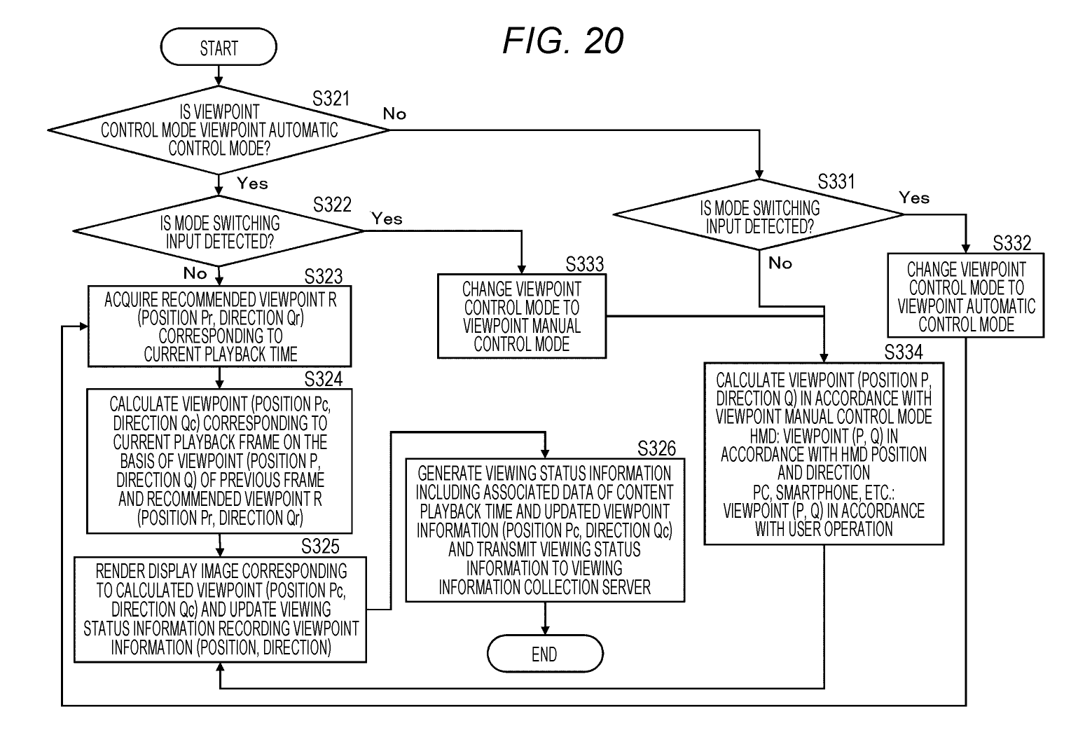

A content display control processing sequence according to the present embodiment executed by the information processing device on the viewing device 70 side will be described below with reference to flowcharts illustrated in FIGS. 19 and 20.

The flowcharts illustrated in FIGS. 19 and 20 are executed by the information processing device on the viewing device 70 side, in other words, the information processing device of the PC 71, the PC 73, the portable terminal (smartphone) 74 illustrated in FIG. 15 or the like. The information processing device includes a data processing unit including a CPU having a computer program execution function, and processing in accordance with the flowcharts is executed under control of the data processing unit. Note that an exemplary hardware configuration of the information processing device will be described later.

The following first describes each processing of the flowchart illustrated in FIG. 19.

The flowchart illustrated in FIG. 19 is a flowchart for description of the sequence of set processing of the automatic viewpoint control mode executed by the information processing device on the viewing device 70 side.

First, the information processing device (viewing device) performs processing of initializing the state of a playback application before start of content playback. Steps starting at step S301 in FIG. 19 are executed upon a press on a playback button or the like.

(Step S301)

At step S301, the information processing device (viewing device) sets, to initial values, display content correspondence viewpoint position P and viewpoint direction Q as data corresponding to a display content. The initial values are included in metadata of the content. Note that the content is a free viewpoint video content.

The viewpoint position P and the viewpoint direction Q are expressed in the free viewpoint video content coordinate system.

Note that, in data recorded in the recommended viewpoint information illustrated in FIG. 17 or the viewing status information described above with reference to FIG. 3, “head position” corresponds to the viewpoint position P, and the pair of “head forward direction” and “head upward direction” corresponds to the viewpoint direction Q. Note that the viewpoint direction Q is expressed in a quaternion number.

(Step S302)

Subsequently at step S302, the information processing device (viewing device) sets the viewpoint control mode to be the automatic viewpoint control mode.

These processing ends the initialization processing.

The following describes, with reference to a flowchart illustrated in FIG. 20, a content display control sequence executed by the information processing device (viewing device) set to the automatic viewpoint control mode.

The processing in accordance with the flowchart illustrated in FIG. 20 is executed by a content playback application activated at the information processing device (viewing device).

In the automatic viewpoint control mode, the playback application executes drawing processing of each image frame of the content in accordance with the recommended viewpoint information.

For example, in a case where the content is rendered at 60 fps, the processing at step S321 and the following steps of the flow illustrated in FIG. 20 is repeatedly executed at each frame, in other words, each 1/60 second until the content playback is stopped by the user (viewer) or the content playback ends (the last frame is rendered).

(Step S321)

First, at step S321, the information processing device (viewing device) determines whether or not the viewpoint control mode is set to be the automatic viewpoint control mode.

In a case where the automatic viewpoint control mode is set, the process proceeds to step S322.

In a case where the automatic viewpoint control mode is not set, the process proceeds to step S331.

(Step S322)

In a case where the automatic viewpoint control mode is set, the information processing device determines at step S322 whether or not mode switching input is detected.

In a case where no mode switching input is detected, the process proceeds to step S323.

In a case where mode switching input is detected, the process proceeds to step S333.

(Step S323)

In a case where no mode switching input is detected, the information processing device acquires “recommended viewpoint information R” at the current playback time included in the metadata of the content at step S323, and the process proceeds to step S324.

The “recommended viewpoint information R” is information including the data described above with reference to FIG. 17.

The following describes exemplary processing using a head position, a head forward direction, and a head upward direction included in the recommended viewpoint information R.

A head position Pr and a head direction Qr (calculated from the head forward direction and the head upward direction) included in the recommended viewpoint information R at the current playback time is acquired.

The head direction Qr is expressed in a quaternion number.

(Step S324)

Subsequently at step S324, the information processing device calculates a recommended viewpoint at the current playback time.

This recommended viewpoint calculation processing uses:

the viewpoint position P and the viewpoint direction Q of the previous frame; and

the head position Pr and the head forward direction Qr as record data of the recommended viewpoint information R acquired at step S323.

A viewpoint position Pc of the recommended viewpoint at the current playback time is calculated in accordance with an equation below through linear interpolation (lerp) using the viewpoint position P of the previous frame and the head position Pr included in the recommended viewpoint information R.

Pc=(1−t)P+tPr

where t is a parameter of 0≤t≤1.

Similarly, a viewpoint direction Qc at the current playback time is calculated through spherical linear interpolation (slerp) using the viewpoint direction Q of the previous frame and the head direction Qr obtained from the recommended viewpoint information R.

(Step S325)

Subsequently at step S325, the information processing device renders a content of an image region corresponding to the recommended viewpoint at the current playback time calculated at step S324 on the display unit of the viewing device.

Note that., in a case where a FoV can be set as a rendering parameter, a FoV included in the recommended viewpoint information R is set.

In addition, the information processing device updates viewpoint information (position, direction) to be recorded in the viewing status information transmitted to the viewing information collection server to viewpoint information corresponding to the current display content.

P and Q are updated with Pc and Qc, respectively.

(Step S326)

Subsequently at step S326, the information processing device generates viewing status information including the viewpoint information (position Pc, direction Qc) updated at step S325 and correspondence data of the content playback time, and transmits the viewing status information to the viewing information collection server.

(Steps S331 and S332)

In a case where it is determined at step S321 that the automatic viewpoint control mode is not set, the information processing device determines at step S331 whether or not mode switching input is detected.

In a case where mode switching input is detected, the process proceeds to step S332, and the viewpoint control mode is changed to the automatic viewpoint control mode.

In a case where no mode switching input is detected, the process proceeds to step S334.

In a case where mode switching input is detected at step S322, switching from the automatic viewpoint control mode to the manual viewpoint control mode is performed at step S333, and the process proceeds to step S334.

(Step S334)

At step S334, the information processing device executes content display control in the manual viewpoint control mode.

Specifically, a viewpoint (position P, direction Q) in accordance with the manual the viewpoint control mode is calculated, and video display is performed in accordance with the calculated viewpoint.

In a case of a HMD, video display is performed in accordance with a viewpoint (P, Q) in accordance with the position and direction of the HMD.

Furthermore, in a case of a PC, a smartphone, or the like, video display is performed in accordance with a viewpoint (P, Q) in response to a user operation.

[2-(c). Embodiment of Execution of Content Automatic Chapter Division Processing]

The following describes an embodiment in which content automatic chapter division processing is executed.

The embodiment described below is an embodiment in which a scene switch point is detected on the basis of a viewing status analysis result, for example, the degree of temporally sequential change of a heat map, and the scene switch point is set as a chapter switching point.

For example, the free viewpoint video distribution server clusters the head position and the head direction of the recommended viewpoint information in a time direction, records, as a scene switch point, a content playback time at which the head position and the head direction change beyond an appropriate threshold, and distributes a list of the times as scene switch point information to the viewing device on the user side as meta information corresponding to a content.

For example, the viewing device (such as a PC) on the user side can display, on the basis of “scene switch point information”, a mark or a sign meaning a scene switch point at the time position of a progress bar indicating the content playback time. Furthermore, an operation such as movement to the next or previous scene switch point can be performed by starting playback from a time in the list.

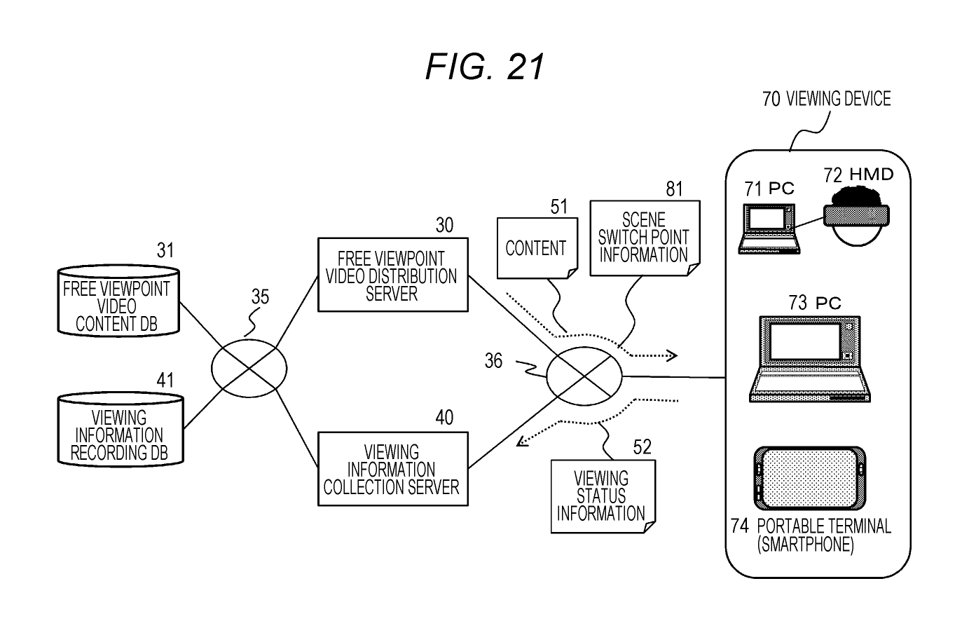

FIG. 21 is a diagram illustrating an exemplary configuration of an information processing system configured to execute provision of scene switch point information 81 and processing using the scene switch point information 81.

Similarly to the information processing system described above with reference to FIG. 1, the free viewpoint video distribution server 30 acquires, through the network 35, a free viewpoint video content stored in the free viewpoint video content database 31, and transmits the acquired free viewpoint video content to the information processing device (content output device) 70 on the user (viewer) side through the network 36.

Similarly to FIG. 15 described above, FIG. 21 illustrates, as exemplary viewing devices 70, the PC 73 and the portable terminal (smartphone) 74 in addition to a combination of the PC 71 and the HMD 72 configured to display an image rendered by the PC 71 as described with reference to FIG. 1.

Similarly to the processing described above with reference to FIG. 1 and the following drawings, the viewing device 70 transmits the viewing status information 52 having the data configuration illustrated in FIG. 3 to the viewing information collection server 40.

The viewing information collection server 40 stores the collected viewing status information in the viewing information record database 41 connected through the network 35.

In the information processing system illustrated in FIG. 21, the free viewpoint video distribution server 30 transmits the scene switch point information 81 to the viewer device 70.

In the present embodiment, the free viewpoint video distribution server 30 analyzes the viewing status information stored in the viewing information record database 41, generates the scene switch point information 81 on the basis of a result of the analysis, and transmits the scene switch point information 81 to the viewer device 70.

The viewer device 70 can know a content scene switch point in advance by using the scene switch point information 81, and can display a mark or sign meaning the scene switch point at the time position of a progress bar indicating the content playback time. Furthermore, an operation such as movement to the next or previous scene switch point can be performed by starting playback from a time in the list.

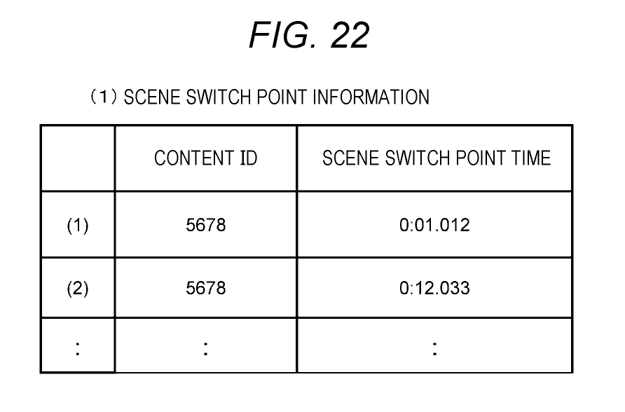

The following describes, with reference to FIG. 22, an exemplary data configuration of the scene switch point information 81 generated by the free viewpoint video distribution server 30 on the basis of the viewing status information stored in the viewing information record database 41, and transmitted to the viewer device 70.

As illustrated in FIG. 22, the scene switch point information 81 is generated as correspondence data of a content ID and a scene switch point time.

This data records a scene switch point time of a content specified by a content ID.

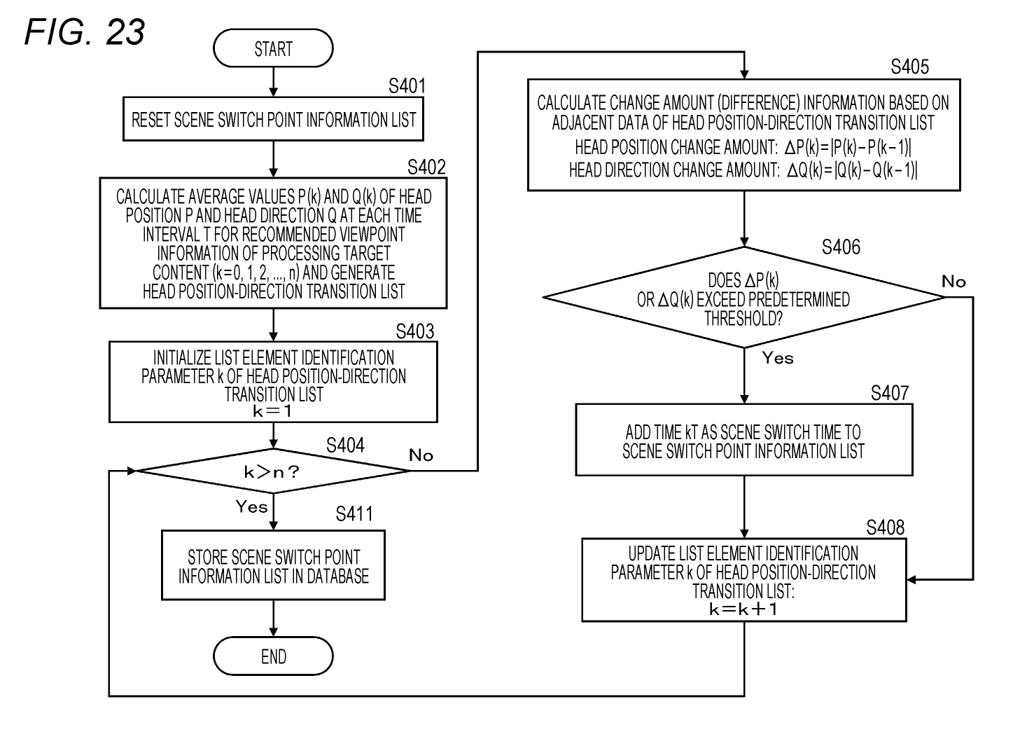

The following describes the generation sequence of “scene switch point information”, which is executed by the free viewpoint video distribution server 30 as the information processing device, with reference to the flowchart illustrated in FIG. 23.

The following describes processing at each step in the flowchart illustrated in FIG. 23.

(Step S401)

First, at step S401, the information processing device (free viewpoint video distribution server 30) resets the “scene switch point information list”. In other words, the list is emptied.

(Step S402)

Subsequently at step S402, the information processing device acquires record data of the recommended viewpoint information of a processing target content, calculates average values P(k) and Q(k) of the head position P and the head direction Q at each time interval T (k=0, 1, 2, . . . , n), and generates a head position-direction transition list.

Specifically, values obtained by averaging the position and direction of a viewpoint included in the recommended viewpoint information of the content over the interval of T seconds are calculated. T is a predetermined fixed value, and is, for example, five seconds or the like. n+1 parts are obtained through n-division of the entire content at the interval of T seconds.

The averages P(k) and Q(k) of the head position P and the direction Q are calculated for each part.

P(k) and Q(k) denote the averages of the head position and direction for T seconds from time kT.

(Step S403)

Subsequently at step S403, the information processing device initializes a list element identification parameter k of the head position-direction transition list generated at step S402 (k=1).

(Step S404)

Subsequently at step S404, the information processing device determines whether or not the list element identification parameter k is larger than a maximum value n.

In a case where k>n holds, it is determined that the generation processing of the head position-direction transition list has ended, and the process proceeds to step S411.

In a case where k>n does not hold, it is determined that the generation processing of the head position-direction transition list has not ended, and the process proceeds to step S405.

(Step S405)

Subsequently at step S405, the information processing device calculates change amount (difference) information based on adjacent list elements listed in the head position-direction transition list.

The following two change amounts are calculated.

Head position change amount: ΔP(k)=|P(k)−P(k−1)|

Head direction change amount: ΔQ(k)=|Q(k)−Q(k−1)|

(Step S406)

Subsequently at step S406, the information processing device determines whether or not the change amount (difference) ΔP(k) or ΔQ(k) calculated at step S405 has exceeded a predetermined threshold.

Note that the threshold is a threshold defined in advance for each of the change amounts (differences) ΔP(k) and ΔQ(k), and is a threshold determined in advance in accordance with the content.

In a case where it is determined that the change amount (difference) ΔP(k) or ΔQ(k) calculated at step S405 has exceeded the predetermined threshold, the process proceeds to step S407.

On the other hand, in a case where it is determined that the change amount (difference) ΔP(k) or ΔQ(k) calculated at step S405 has not exceeded the predetermined threshold, the process proceeds to step S408.

(Step S407)

In a case where it is determined that the change amount (difference) ΔP(k) or ΔQ(k) calculated at step S405 has exceeded the predetermined threshold, time kT is added as a scene switch time to the scene switch point information list at step S407.

In other words, in a case where the change amount (difference) is larger than the threshold for adjacent list elements listed in the head position-direction transition list, the scene switch time kT is recorded in the scene switch point information list.

(Step S408)

After the processing at step S407 ends or in a case where it is determined at step S406 that the change amount (difference) ΔP(k) or ΔQ(k) has not exceeded the predetermined threshold, the process proceeds to step S408.

At step S408, update of the list element identification parameter k of the head position-direction transition list (k=k +1) is executed, and the processing starting at step S404 is executed on the basis of the parameter after the update.

(Step S411)

At step S404, in a case where it is determined that the list element identification parameter k is larger than the maximum value n, in other words, in a case where k>n holds, it is determined that the generation processing of the head position-direction transition list has ended, and the process proceeds to step S411.

At step S411, the generated scene switch point information list is stored in a database, and the process ends.

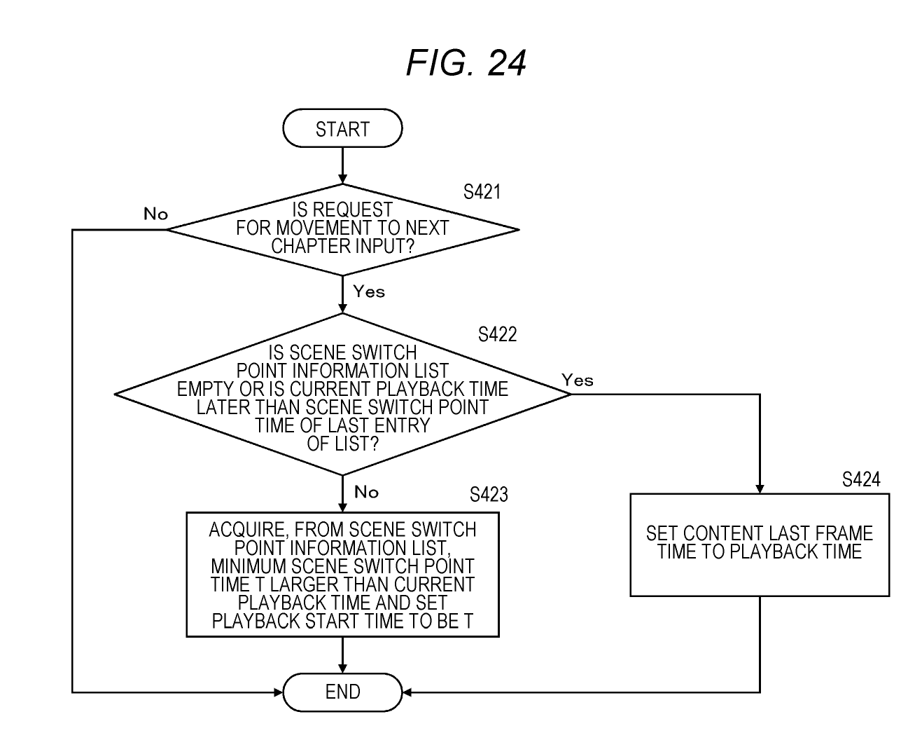

The following describes, with reference to the flowchart illustrated in FIG. 24, processing performed when a chapter moving operation is executed during playback of a free viewpoint content at the information processing device on the client side, in other words, on the viewing device 70 side.

Note that the content played back and the scene switch point information list are already acquired. Furthermore, the processing in accordance with the flowchart illustrated in FIG. 24 is repeatedly executed for each playback frame.

(Step S421)

First, at step S421, the information processing device (the viewing device) determines whether or not a request for movement to the next chapter is input.

In a case where the request for movement to the next chapter is input, the process proceeds to step S422. Otherwise, the process ends.

(Step S422)

Subsequently at step S422, the information processing device determines whether or not the scene switch point information list is empty or whether or not the current playback time is later than the scene switch point time of the last entry of the list.

In a case where the scene switch point information list is empty or the current playback time is later than the scene switch point time of the last entry of the list, the process proceeds to step S424.

In a case where the scene switch point information list is not empty or the current playback time is later than the scene switch point time of the last entry of the list, the process proceeds to step S423.

(Step S423)

At step S422, in a case where the scene switch point information list is not empty or the current playback time is later than the scene switch point time of the last entry of the list, the process proceeds to step S423.

At step S423, the information processing device acquires a minimum scene switch point time larger than the current playback time from the scene switch point information list, and sets the playback start time to be T.

In other words, chapter moving processing is performed.

(Step S424)

At step S422, in a case where it is determined that the scene switch point information list is empty or the current playback time is later than the scene switch point time of the last entry of the list, the process proceeds to step S424.

At step S424, the information processing device sets the time of the last frame of the content to be the playback time.

In other words, processing of moving to playback processing of the last frame is performed.

Note that, the chapter moving processing described with reference to the flow illustrated in FIG. 24 is exemplary chapter moving processing toward the content backward side, but in a case of chapter movement toward the forward side, the chapter moving processing can be performed with reference to the scene switch point information list similarly.

[2-(d). Embodiment of Execution of Advertisement Display Control]

The following describes an embodiment in which advertisement display control is executed.

The embodiment described below is an embodiment in which effective advertisement display processing is achieved on the basis of a viewing status analysis result, for example, a heat map.

The “viewing rate” of each image region in a free viewpoint video is calculated on the basis of a viewing status analysis result, for example, a heat map, and the following processing is performed on the basis of the viewing rate.

In a case where an advertisement is superimposed on a content and provided, and an advertisement rate is automatically calculated on the basis of the viewing rate.

The following embodiment describes, as exemplary advertisement display, a configuration in which a CG virtual signboard advertisement is distributed and superimposed in a free viewpoint video content. An advertiser registers the advertisement to an advertisement database with specifications of the budget of the advertisement, a texture image as the signboard advertisement, and a rank.

For example, any of ranks at three levels is set to the rank in advance.

The ranks at three levels are ranks in accordance with the gaze point distribution status of a gaze point heat map generated on the basis of the viewing status information transmitted from the viewing device.

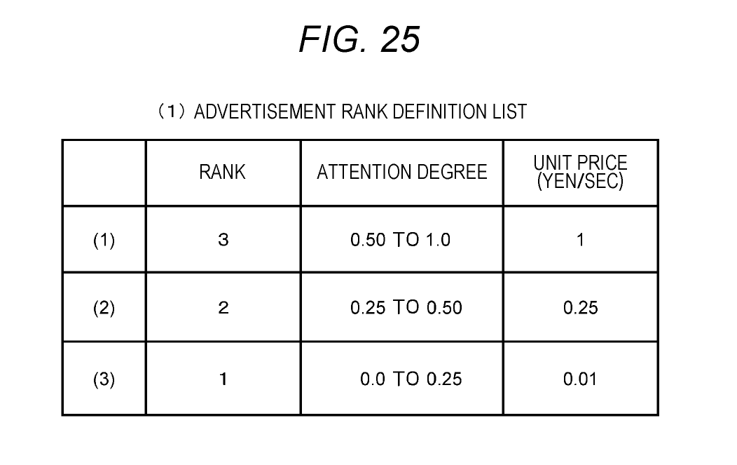

FIG. 25 illustrates an exemplary advertisement rank definition list.

As illustrated in FIG. 25, the advertisement rank definition list is data in which Ranks 3 to 1 are each associated with an attention degree of 0 to 1.0 and a unit price (yen/sec).

The attention degree is data corresponding to the gaze point distribution status of a gaze point heat map generated on the basis of the viewing status information transmitted from the viewing device.

The attention degree is set to be high for a region including a lattice with a larger number of gaze points on the gaze point heat map, and the attention degree is set to be low for a region including a lattice with a small number of gaze points on the gaze point heat map.

The unit price is set in accordance with the attention degree, high for a lattice region having a high attention degree, and low for a region having a low attention degree.

The advertiser determines the rank on the basis of this advertisement rank definition, and registers the advertisement to the advertisement database together with data of the texture image as the signboard advertisement, the rank, the budget, and the like.

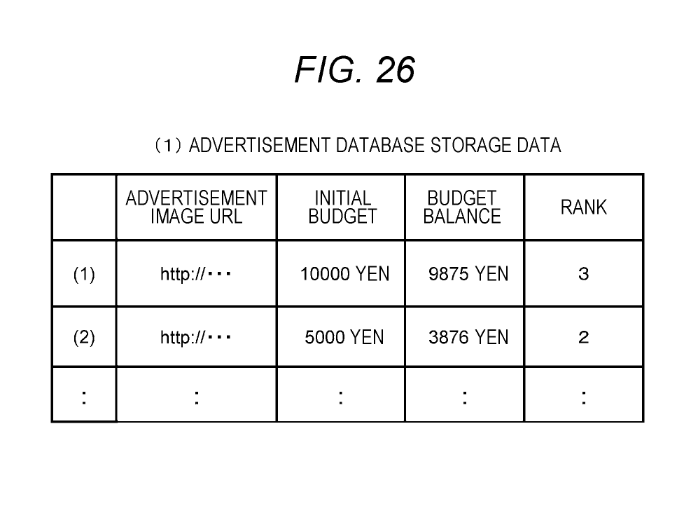

FIG. 26 illustrates exemplary registered data of the advertisement database.

As illustrated in FIG. 26, the advertisement database registers a URL for acquiring data of the texture image as the signboard advertisement, the initial budget, the budget balance, and the rank in association with each other.

The free viewpoint video distribution server that distributes an advertisement together with a free viewpoint video content superimposes the advertisement registered to the advertisement database on the content, transmits the advertisement to the viewing device on the user (viewer) side, and displays the advertisement on the display unit.

In this advertisement provision processing, the free viewpoint video distribution server performs advertisement selection and advertisement output position determination processing in accordance with a predetermined algorithm.

In the advertisement output position determination processing, a texture of an image of the advertisement is displayed in place of the surface of a lattice (determined from the heat map) that satisfies the attention degree corresponding to the rank of the advertisement.

Furthermore, the unit price is subtracted from the budget at each display time of one second, and the corresponding advertisement is removed from the advertisement DB when the budget runs out (becomes zero).

Note that, instead of drawing the advertisement image as the texture of the lattice surface, the advertisement may be disposed so that the center of a rectangle on which the advertisement image is placed contacts a point where a normal on the spherical surface of a circumscribing sphere of the lattice aligns with the head position of the viewer, and so that the upward direction of the advertisement aligns with the head upward direction of the viewer.

In this example, the budget is all consumed on the server side, but charging may be made only when it is determined that the advertisement is actually “watched” or “has entered the field of view” on the basis of the gaze point and the FoV of the viewing status information transferred from the client.

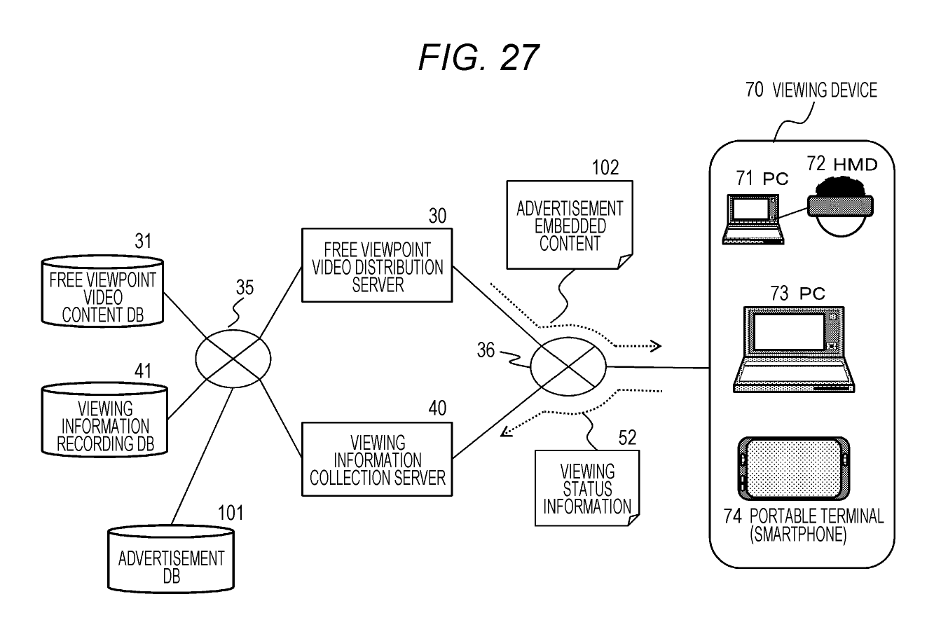

FIG. 27 is a diagram illustrating an exemplary configuration of an information processing system configured to execute the present embodiment.

Similarly to the information processing system described above with reference to FIG. 1, the free viewpoint video distribution server 30 acquires, through the network 35, a free viewpoint video content stored in the free viewpoint video content database 31, and transmits the acquired free viewpoint video content to the information processing device (content output device) 70 on the user (viewer) side through the network 36.

Similarly to FIG. 15 described above, FIG. 27 illustrates, as exemplary viewing devices 70, the PC 73 and the portable terminal (smartphone) 74 in addition to a combination of the PC 71 and the HMD 72 configured to display an image rendered by the PC 71 as described with reference to FIG. 1.

Similarly to the processing described above with reference to FIG. 1 and the following drawings, the viewing device 70 transmits the viewing status information 52 having the data configuration illustrated in FIG. 3 to the viewing information collection server 40.

The viewing information collection server 40 stores the collected viewing status information in the viewing information record database 41 connected through the network 35.

In the information processing system illustrated in FIG. 27, the free viewpoint video distribution server 30 transmits an advertisement embedded content 102 to the viewer device 70.

The advertisement embedded content 102 is embedded with advertisement information (texture information including advertisement data) acquired on the basis of a URL recorded in the advertisement database described with reference to FIG. 26.

Note that the advertisement database storage data described with reference to FIG. 26 is stored in an advertisement database 101 illustrated in FIG. 27.

The free viewpoint video distribution server 30 that distributes an advertisement together with a free viewpoint video content transmits the advertisement embedded content 102 in which an advertisement registered to the advertisement database 101 is superimposed on the content to the viewing device 70 on the user (viewer) side, and displays the advertisement embedded content 102 on the display unit.

In this advertisement provision processing, the free viewpoint video distribution server 30 performs advertisement selection and advertisement output position determination processing in accordance with a predetermined algorithm.

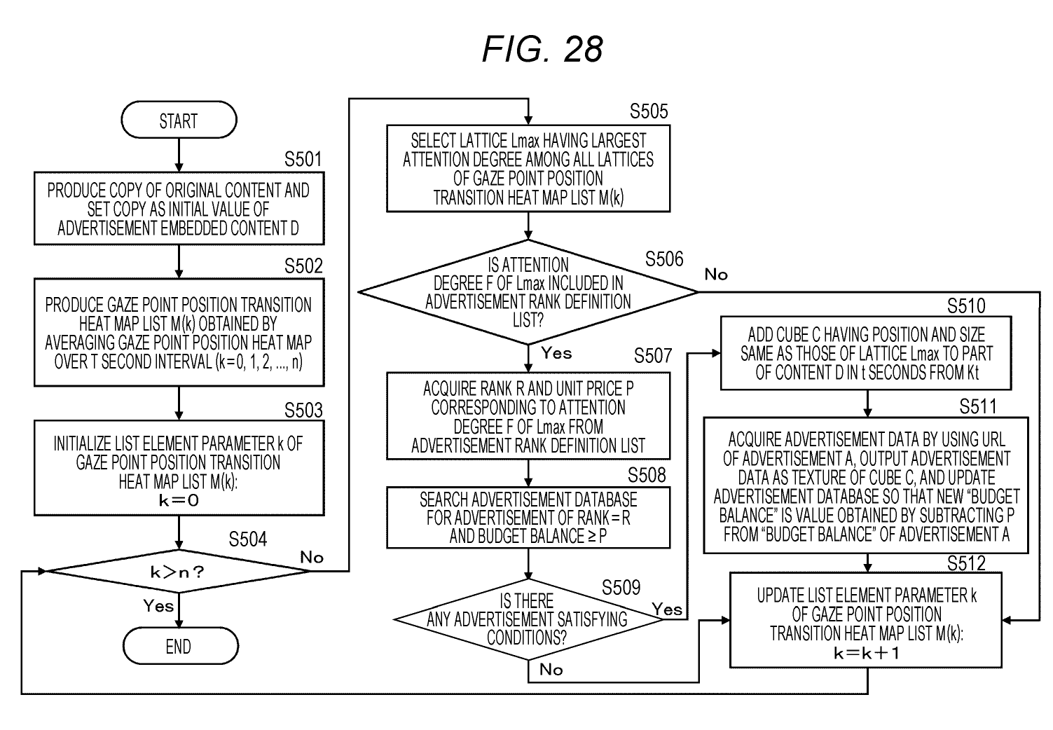

The following describes, with reference to the flowchart illustrated in FIG. 28, the sequences of the advertisement selection processing and the advertisement output position determination processing executed by the free viewpoint video distribution server 30 as the information processing device, advertisement provision processing.

The following describes processing at each step in the flowchart illustrated in FIG. 28.

Note that the flow illustrated in FIG. 28 is executed on assumption that the gaze point position heat map described above with reference to FIG. 6 is already generated as a gaze point position heat map corresponding to a content provided to the user side.

(Step S501)

First, at step S501, the information processing device (free viewpoint video distribution server 30) produces a copy of an original content and sets the copy as the initial value of an advertisement embedded content. D.

The original content is a content transmitted to the viewing device 70 by the free viewpoint video distribution server 30 and is a free viewpoint video content.

(Step S502)

Subsequently at step S502, the information processing device produces a gaze point position transition heat map list M(k) obtained by averaging the gaze point heat map over the interval of T seconds.

T is a predetermined fixed value and, for example, 5 seconds to 15 seconds, or the like. n+1 parts are obtained through n-division of the entire content at the interval of T seconds.

k is a list element parameter of the gaze point position transition heat map list M(k), and

k=0, 1, . . . , n.

(Step S503)

Subsequently at step S503, the information processing device initializes the list element parameter k of the gaze point position transition heat map list M(k), is other words, executes parameter initialization processing as follows:

k=0

(Step S504)

Subsequently at step S504, the information processing device determines whether or not the list element parameter k of the gaze point position transition heat map list M(k) is larger than a parameter maximum value n.

In a case where k>n holds, it is determined that the processing has ended, and the process ends.

In a case where k>n does not hold, the process proceeds to step S505.

(Step S505)

Subsequently at step S505, the information processing device selects a lattice Lmax having the largest attention degree among all lattices of the gaze point, position transition heat map list M(k).

In other words, the lattice Lmax with the largest number of gaze points is selected.

(Step S506)

Subsequently at step S506, the information processing device determines whether or not the attention degree F of Lmax is included in the advertisement rank definition list.

The output value of the heat map is set to be in the range of 0 to 1.0 as described above with reference to FIG. 14.

On the other hand, the set value of the attention degree of the advertisement rank definition list described with reference to FIG. 25 is set to be 0 to 1.0.

In a case as illustrated in FIG. 25, the attention degree is always included in the advertisement rank definition list, but may not be included depending on the content of the advertisement rank definition list.

At step S506, it is determined whether or not there is an entry of the advertisement rank definition list, which is set to an attention degree that matches with the heat map output value of the lattice Lmax having the largest attention degree among all lattices of the gaze point position transition heat map list M(k) selected at step S505.

In a case where there is a matching entry, the process proceeds to step S507, but in a case where there is no matching entry, the process proceeds to step S512.

(Step S507)

At step S506, in a case where it is determined that there is an entry of the advertisement rank definition list, which is set to an attention degree that matches with the heat map output value of the lattice Lmax having the largest attention degree among all lattices of the gaze point position transition heat map list M(k), the process proceeds to step S507.

At step S507, the information processing device selects, from the advertisement rank definition list, the entry of the advertisement rank definition list, which is set to an attention degree that matches with the heat map output value of Lmax, and acquires a rank R and a unit price P set to the entry.

(Step S508)

Subsequently at step S508, the information processing device searches the advertisement database, in other words, the advertisement database storing the data illustrated in FIG. 26, for an advertisement A having a “rank” equal to R and a “budget balance” equal to or larger than P.

(Step S509)

Subsequently at step S509, the information processing device determines whether or not the advertisement A is extracted as a result of the search at step S508.

Specifically, it is determined whether or not the advertisement A having a “rank” equal to R and a “budget balance” equal to or larger than P is extracted.

In a case where the advertisement A is extracted, the process proceeds to step S510, but in a case where the advertisement A is not extracted, the process proceeds to step S512.

(Step S510)

At step S509, in a case where the advertisement A having a “rank” equal to R and a “budget balance” equal to or larger than P is extracted, the process proceeds to step S510.

At step S510, the information processing device adds a cube C having a position and a size same as those of the lattice Lmax selected from the gaze point position transition heat map list M(k) to part of a content D for t seconds from Kt.

The content. D is the copy of the original content generated at step S501.

(Step S511)

Subsequently at step S511, the information processing device selects, from the advertisement database, the URL of the advertisement A extracted as an advertisement satisfying the conditions, and acquires advertisement data by using the URL.

Furthermore, the acquired advertisement data is set to the content D as a texture to be bonded to the cube C generated at step S510.

Furthermore, the advertisement database is updated so that a value obtained by subtracting P from the “budget balance” of the advertisement A is the new value of the “budget balance”.

(Step S512)

Subsequently at step S512, the information processing device executes update processing of the list element parameter k of the gaze point position transition heat map list M(k). In other words,

k=k+1

the above parameter update is executed, and the processing starting at step S504 is executed on the basis of the updated parameter.

At step S504, in a case where the list element parameter k of the gaze point position transition heat map list M(k) is larger than the parameter maximum value n, in other words, in a case where k>n holds, it is determined that the processing has ended, and the process ends.

Furthermore, the generated “advertisement embedded content D” is stored in a content DB so that the generated “advertisement embedded content D” can be distributed in place of the original content.

[2-(e). Embodiment of Execution of Image Quality, Control in Accordance with the Attention Degree]

The following describes an embodiment in which image quality control is executed in accordance with the attention degree.

Specifically, for example, an encode bit rate is controlled on the basis of a viewing status analysis result. Encode control is executed that, on the basis of a heat map, the texture of an object having a high attention degree in a content is encoded at a higher bit rate, and the texture of an object attracting less attention in the content is encoded at a low bit rate.

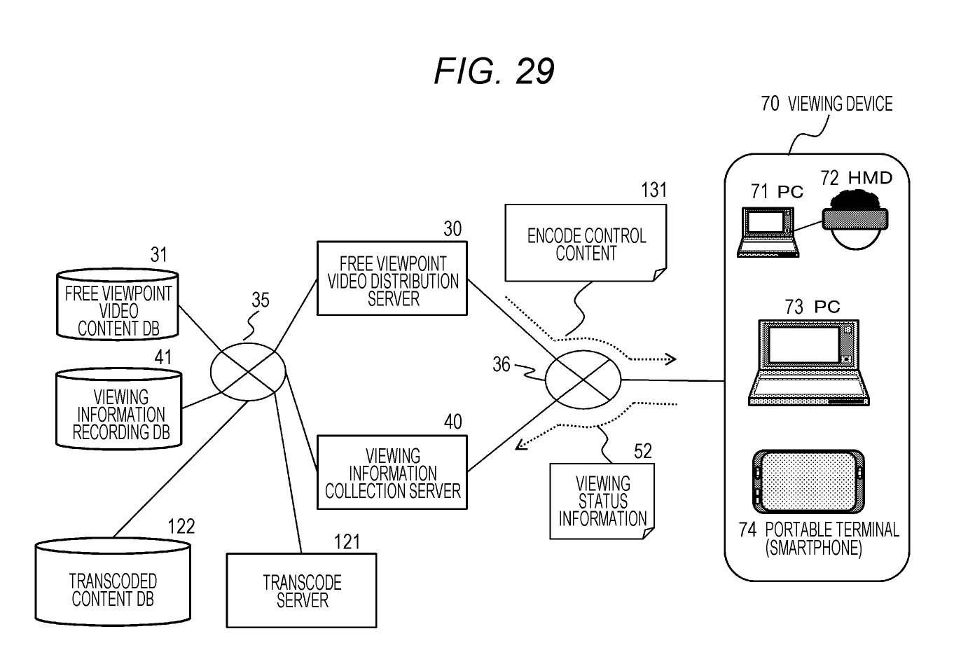

FIG. 29 is a diagram illustrating an exemplary configuration of an information processing system that executes the present embodiment.

Similarly to the information processing system described above with reference to FIG. 1, the free viewpoint video distribution server 30 acquires, through the network 35, a free viewpoint video content stored in the free viewpoint video content database 31, and transmits the acquired free viewpoint video content to the information processing device (content output device) 70 on the user (viewer) side through the network 36.

Similarly to FIG. 15 described above, FIG. 29 illustrates, as exemplary viewing devices 70, the PC 73 and the portable terminal (smartphone) 74 in addition to a combination of the PC 71 and the HMD 72 configured to display an image rendered by the PC 71 as described with reference to FIG. 1.

Similarly to the processing described above with reference to FIG. 1 and the following drawings, the viewing device 70 transmits the viewing status information 52 having the data configuration illustrated in FIG. 3 to the viewing information collection server 40.

The viewing information collection server 40 stores the collected viewing status information in the viewing information record database 41 connected through the network 35.

In the information processing system illustrated in FIG. 29, the free viewpoint video distribution server 30 transmits an encode control content 131 to the viewer device 70.

The encode control content 131 is a content generated by executing such encode control that, on the basis of, for example, a gaze point position heat map generated on the basis of the viewing status information 52, the texture of an object having a high attention degree in the content is encoded at a higher bit rate, and the texture of an object attracting less attention in the content is encoded at a low bit rate.

Note that a server configured to execute such encode processing for each content region is a transcode server 121 illustrated in FIG. 29, and a database storing an encoded content obtained as a result is a transcoded content database 122 illustrated in FIG. 29.

The transcode server 121 determines a content region having a high attention degree and a content region having a low attention degree by using, for example, a gaze point position heat map generated on the basis of the viewing status information generated for a free viewpoint video content, and performs re-encoding with such setting that the bit rate of the texture of an object in a content region having a high attention degree is high. The re-encoded content is stored in the transcoded content database 122.

The free viewpoint video distribution server 30 transmits the encode control content 131 acquired from the transcoded content database 122 to the viewer device 70.

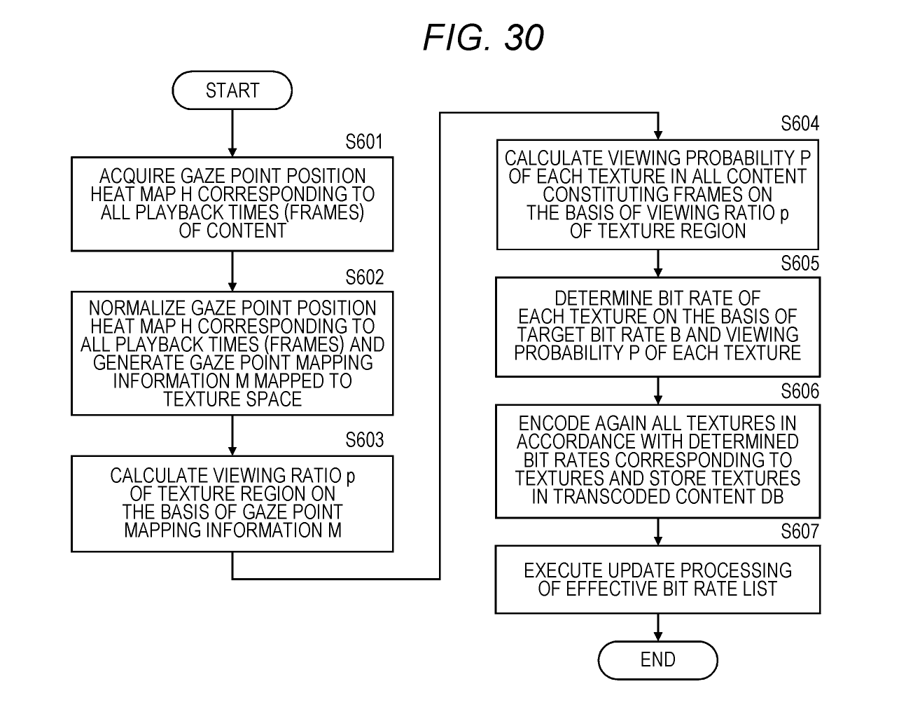

The following describes, with reference to the flowchart illustrated in FIG. 30, the sequence of the free viewpoint video content re-encode processing, which is executed by a transcode server 1210 as the information processing device.

The following describes processing at each step in the flowchart illustrated in FIG. 30.

Note that, the flow illustrated in FIG. 30 is executed on assumption that the gaze point position heat map described above with reference to FIG. 6 is already generated as a gaze point position heat map corresponding to a content provided to the user side.

Furthermore, it is assumed that the free viewpoint video content as the target of re-encoding executed by the transcode server 1210 is provided with re-encode processing at a uniform bit rate in the entire space in the content in advance.

(Step S601)

First, at step S601, the information processing device (the transcode server 121) acquires an all playback times correspondence (all frames correspondence) gaze point position heat map H of a processing target content (free viewpoint video content).

The gaze point position heat map is the heat map described above with reference to FIGS. 6 and 12 to 14, and is a heat map in which data in accordance with the attention degree in the content is expressed.

(Step S602)

Subsequently at step S602, the information processing device executes normalization processing of the gaze point position heat map H corresponding to all playback times (corresponding to all frames), and generates a gaze point mapping information M obtained by mapping this normalized data to a texture space.

The gaze point mapping information M can be obtained by acquiring apex data of polygons included in the three-dimensional lattice of the normalized gaze point position heat map H and referring to texture coordinates from the data.

Note that a texture corresponds to, for example, an image of each object or each region included in the content, and has a value that changes in a temporally sequential manner.

(Step S603)

Subsequently at step S603, the information processing device calculates a viewing ratio p of a texture region on the basis of the gaze point mapping information M. The viewing ratio p corresponds to the viewing ratio of each lattice (the number of gaze points in the lattice) relative to the viewing amount of the entire content (total amount over the number of gaze points).

Note that, in a case where there is no viewing log, processing of assuming that p is same for all textures may be performed.

(Step S604)

Subsequently at step S604, the information processing device calculates a viewing probability P of each texture in all content constituting frames on the basis of the viewing ratio p of the texture region.

The viewing probability P can be calculated by accumulating p at all playback times and dividing the accumulated p by the number of samplings of the playback time.

(Step S605)

Subsequently at step S605, the information processing device determines a bit rate applied to encoding of each texture in accordance with a total bit rate B as a target defined in advance and the viewing probability P of the texture.

The bit rate of each texture may be simply calculated with B×P, but setting of providing a lower limit is desirable to prevent significant image quality degradation.

(Step S606)

Subsequently at step S606, the information processing device executes re-encode processing of all textures included in the content in accordance with the bit rate of each texture determined at step S605, and stores the textures in the transcoded content database 122.

(Step S607)

Subsequently at step S607, the information processing device updates an effective bit rate list recording the bit sate of each texture corresponding to the content.

Note that the effective bit rate list is stored in the transcoded content database 122 together with the content.

The free viewpoint video distribution server 30 transmits the encode control content 131 acquired from the transcoded content database 122 to the viewer device 70. Note that, in this case, the above-described effective bit rate list is transmitted as the metadata of the content.

Through this processing, an image content in which only a region having a high attention degree becomes high image quality data and a region having a low attention degree has a low image quality is transmitted to the viewing device through a network. As a result, data transmission efficiency increases, and it is possible to prevent playback delay of the content due to a network delay.

Note that, although in the above-described processing, an example in which the bit rate of a texture is changed is described, a bit rate change target is not limited to a texture, but may be, for example, model data.

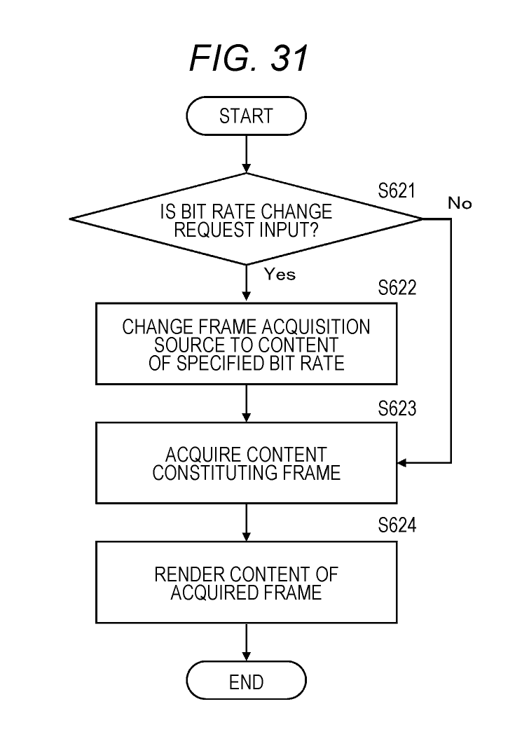

The following describes the sequence of content output processing executed by the viewing device 70 on the client side with reference to the flowchart illustrated in FIG. 31.

The flow illustrated in FIG. 31 is executed by the information processing device configured to execute content rendering on the viewing device 70 side.

A playback application activated at the information processing device performs processing of drawing at each frame.

In a case where the content is rendered at 60 fps, steps of the flow illustrated in FIG. 31 are repeatedly executed at each 1/60 second until content playback is stopped by the user or ends (the last frame is drawn).

(Step S621)

First, at step S621, the information processing device determines whether or not a bit rate change request is input.

In a case where a bit rate change request is input, the process proceeds to step S622, or in a case where no bit rate change request is input, the process proceeds to step S623.

Note that an effective bit rate list recording the bit rate for each texture of the content is acquired as metadata together with the content.

(Step S622)

In a case where a bit rate change request is input, at step S622, the information processing device changes a content acquisition source to acquire an image frame in accordance with the bit rate requested to be changed. Similarly to the bit rate list, the URL of the content is acquired as the metadata.

(Step S623)

Subsequently at step S623, the information processing device acquires a playback frame.

(Step S624)

Subsequently at step S624, the information processing device renders the content of the frame acquired at step S623.

Through these processing, the viewing device on the client side can display the content at image quality in accordance with a request from the user (viewer).

[2-(f). Embodiment of Execution of Charge Processing Based on Viewing Status Analysis Result]

The following describes an embodiment in which charge processing based on a viewing status analysis result is executed.

Specifically, for example, the viewing rate of each image region is calculated on the basis of a gaze point position heat map, playback of a popular image region having a high viewing rate is charged at high price, but playback of an unpopular image region is charged at low price. The embodiment enables automation of setting of the viewing price of the content.

For example, the popularity degrees and attention degrees of a viewpoint position and a gaze point position (or a FoV central region) are acquired from the heat map, the viewing price is calculated from the acquired data and the viewing status information of the viewer for each frame, and charging is performed.

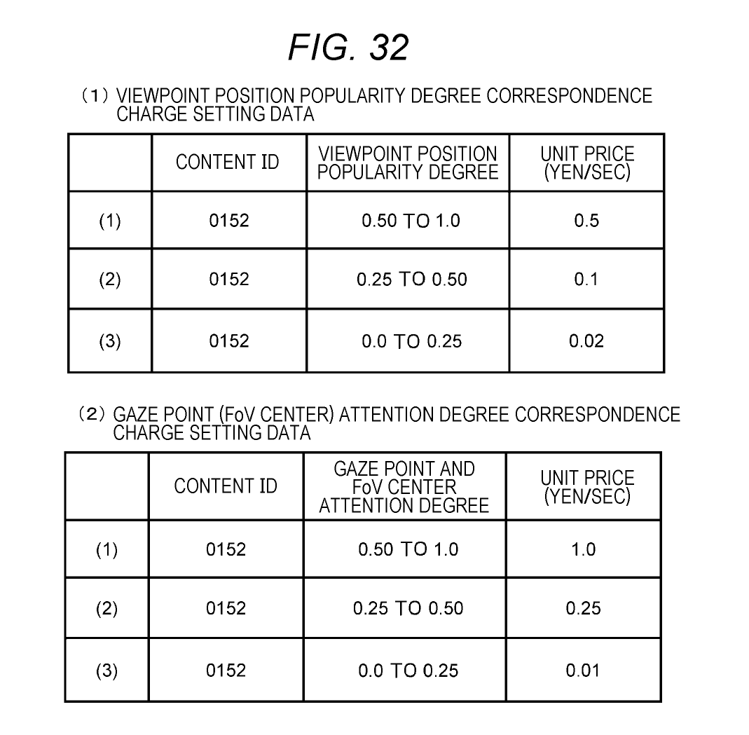

FIG. 32 illustrates the following drawings.

(1) Viewpoint position popularity degree correspondence unit price setting data

(2) Gaze point (or FoV center) attention degree correspondence unit price setting data

(1) The viewpoint position popularity degree correspondence unit price setting data is correspondence data of the content ID, the popularity degree of the viewpoint position, and the unit price.

The popularity degree of the viewpoint position is calculated on the basis of a viewpoint position heat map generated from the viewing status information.

(2) The gaze point (or FoV center) attention degree correspondence unit price setting data is correspondence data of the content ID, the attention degree of the gaze point (or FoV center), and the unit price.

The attention degree of the gaze point (or FoV center) is calculated on the basis of a gaze point position heat map generated from the viewing status information.

A viewing charge price of each frame is calculated from the unit price setting data and the content frame rate (for example, 60 fps or 30 fps). For example, when the content has a bit rate of 30 fps, the viewpoint position has a popularity degree of 0.4, and the gaze point has an attention degree of 0.7 at a time, the viewing price of a frame at the time can be calculated to be (0.1+1)/30=0.037 yen (rounded at the last digit). When the sum of the viewing price of each frame is calculated in this manner, viewing of the entire content can be charged.

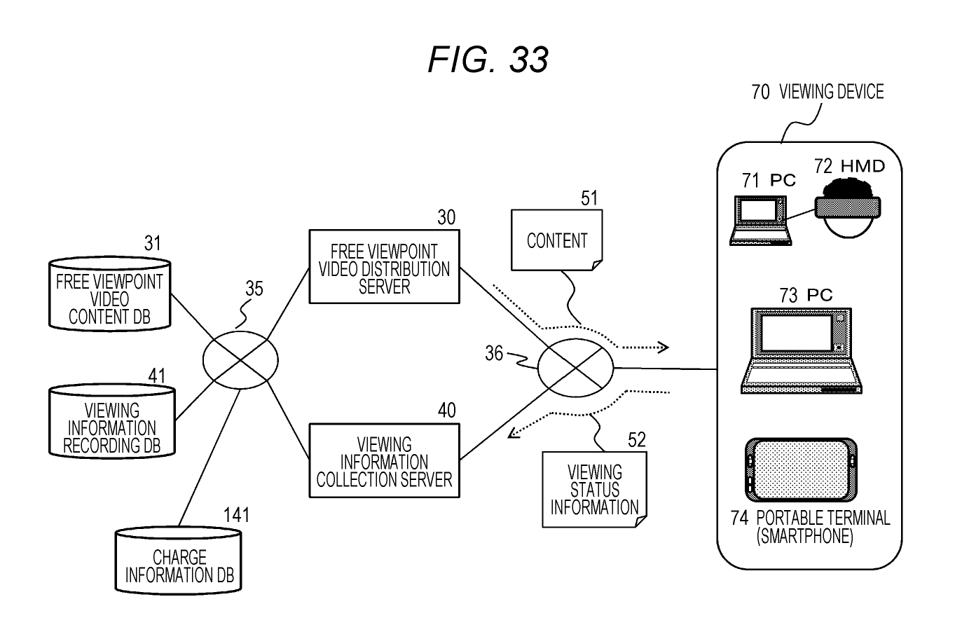

FIG. 33 is a diagram illustrating an exemplary configuration of an information processing system configured to execute charge processing based on a viewing status analysis result.

Similarly to the information processing system described above with reference to FIG. 1, the free viewpoint video distribution server 30 acquires, through the network 35, a free viewpoint video content stored in the free viewpoint video content database 31, and transmits the acquired free viewpoint video content to the information processing device (content output device) 70 on the user (viewer) side through the network 36.

Similarly to FIG. 15 described above, FIG. 33 illustrates, as exemplary viewing devices 70, the PC 73 and the portable terminal (smartphone) 74 in addition to a combination of the PC 71 and the HMD 72 configured to display an image rendered by the PC 71 as described with reference to FIG. 1.

Similarly to the processing described above with reference to FIG. 1 and the following drawings, the viewing device 70 transmits the viewing status information 52 having the data configuration illustrated in FIG. 3 to the viewing information collection server 40.

The viewing information collection server 40 stores the collected viewing status information in the viewing information record database 41 connected through the network 35.

In the information processing system illustrated in FIG. 33, the following data described above with reference to FIG. 32 are stored in the charge information database 141.
(1) Viewpoint position popularity degree correspondence unit price setting data
(2) Gaze point (or FoV center) attention degree correspondence unit price setting data

The free viewpoint video distribution server 30 executes charge processing on each user (viewer) on the basis of these data stored in the charge information database 141.

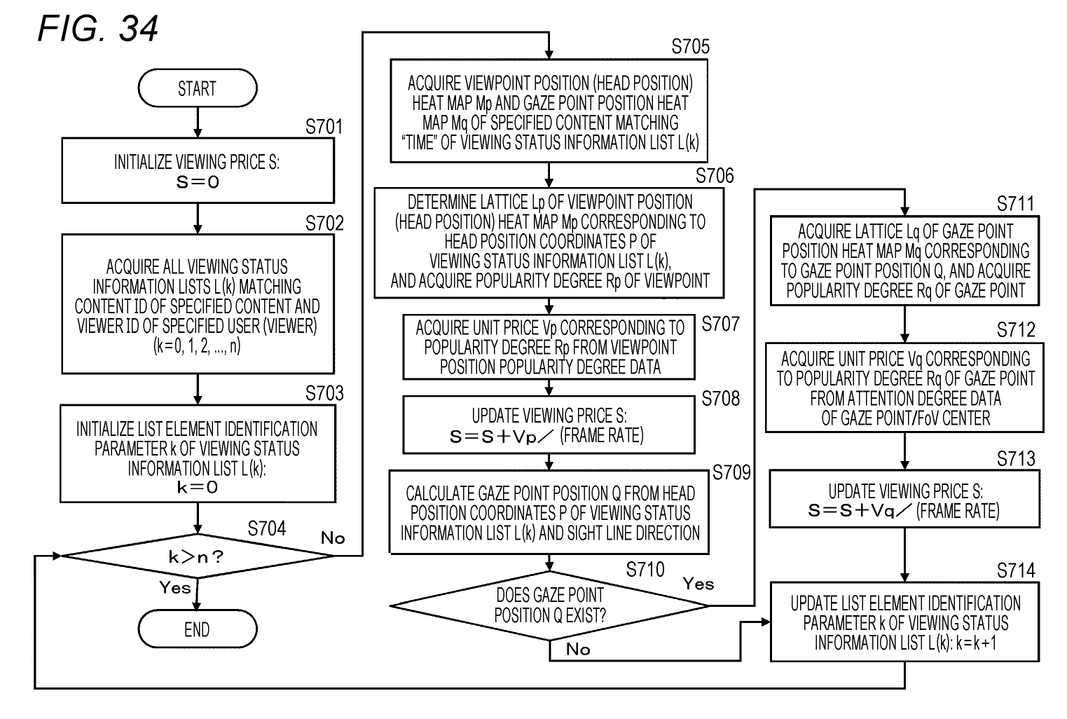

The following describes, with reference to the flowchart illustrated in FIG. 34, the sequence of content viewing price calculation executed by the free viewpoint distribution server 30 as the information processing device.

The following describes processing at each step in the flowchart illustrated in FIG. 34.

(Step S701)

First, at step S701, the information processing device (free viewpoint video distribution server 30) resets a “viewing price S”.

The “viewing price S” is a variable for calculating the viewing price of a specified user (viewer) as a processing target for a specified content as a processing target.

At step S701, the information processing device resets the “viewing price S” to set S=0, in other words, the viewing price=0.

(Step S702)

Subsequently at step S702, the information processing device acquires all viewing status information lists L(k) that match the content ID of the specified content as a processing target and the viewer ID of the specified user (viewer) as a processing target.

k is a list element identification parameter for identifying a list element of the viewing status information list L,(k), and k=0, 1, 2, . . . , n.

(Step S703)

Subsequently at step S703, the information processing device executes initialization processing of the list element identification parameter.

k=0

is set.

(Step S704)

Subsequently at step S704, the information processing device determines whether or not the list element identification parameter k is larger than a maximum value n.

In a case where k>n holds, it is determined that the content viewing price calculation processing has ended, and the process ends.

In a case where k>n does not hold, it is determined that the content viewing price calculation processing has not ended, and the process proceeds to step S705.

(Step S705)

Subsequently at step S705, the information processing device acquires a viewpoint position (head position) heat map Mp and a gaze point position heat map Mq of the specified content that match a viewing price calculation time of the viewing status information list L(k).

(Step S706)

Subsequently at step S706, the information processing device determines a lattice Lp of the viewpoint position (head position) heat map Mp corresponding to a head position (viewpoint position) coordinates P of the viewing status information list L(k), and acquires a popularity degree Rp corresponding to the viewpoint position.

(Step S707)

Subsequently at step S707, the information processing device acquires a unit price Vp corresponding to the popularity degree Rp on the basis of the viewpoint position popularity degree data. The unit price is a price per second.
This processing is unit price calculation processing using data below

(1) Viewpoint position popularity degree correspondence unit price setting data

which is described above with reference to FIG. 32(1).

(Step S708)

Subsequently at step S708, the information processing device updates the viewing price S.

Specifically, the viewing price is calculated by the following calculation formula.

S=S+Vp/(frame rate)

This calculated value S is set as a new viewing price S after update.

(Step S709)

Subsequently at step S709, the information processing device calculates the gaze point position Q from the head position coordinates P and the sight line direction of the viewing status information list L(k).

This gaze point position calculation processing corresponds to the processing described above with reference to FIG. 5.

(Step S710)

Subsequently at step S710, the information processing device determines whether or not the gaze point position Q exists in the content.

In a case where the gaze point position Q exists, the process proceeds to step S711, but in a case where the gaze point position Q does not exist, the process proceeds to step S714.

(Step S711)

At step S710, in a case where it is determined that the gaze point position Q exists in the content, subsequently at step S711, the information processing device acquires a lattice Lq of the gaze point position heat map Mg corresponding to the gaze point position Q, and acquires a popularity degree Rq of the gaze point thereof.

(Step S712)

Subsequently at step S712, the information processing device acquires a unit price Vq corresponding to the popularity degree Rq on the basis of the gaze point (or FoV center) attention degree correspondence unit price setting data. The unit price is a price per second.

This processing is unit price calculation processing using data below

(1) gaze point (or FoV center) attention degree correspondence unit price setting data

which is described above with reference to FIG. 32(2).

(Step S713)

Subsequently at step S713, the information processing device updates the viewing price S.

Specifically, the viewing price is calculated by the following calculation formula.

S=S+Vq/(frame rate)

This calculated value S is set as a new viewing price S after update.

(Step S714)

Subsequently at step S714, the information processing device executes update processing of the list element parameter k of the viewing status information list L(k). In other words,

k=k+1

The above parameter update is executed, and the processing starting at step S704 is executed on the basis of the updated parameter.

At step S704, in a case where the list element parameter k of the viewing status information list L(k) is larger than the parameter maximum value n, in other words, in a case where k>n holds, it is determined that the processing has ended, and the process ends.

[2-(g). Embodiment of Attention Region Analysis of Audience of Concert, Movie Film, and the Like]

The following describes an embodiment in which the attention region of the audience of a concert, a movie film, and the like is analyzed.

Specifically, this embodiment is an embodiment in which, for example, a sight line detection instrument (such as a HMD) is mounted on the audience of a concert, a movie film, and the like to acquire and analyze sight line information and the like of the audience.

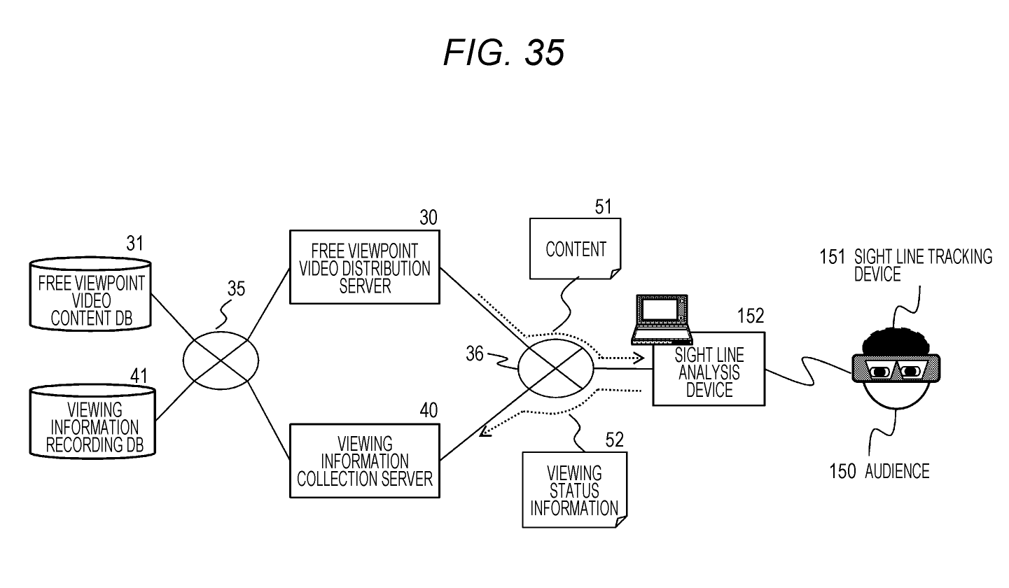

As illustrated in FIG. 35, for example, a sight line tracking device 151 as a sight line detection instrument (such as a HMD) is mounted on audience 150 of a concert, a movie film, or the like, and a sight line analysis device 152 generates, on the basis of an output from the sight line tracking device 151, viewing status information made of sight line position (head position) and sight line direction information and the like of the audience 150.

In other words, the viewing status information including the data described above with reference to FIG. 3 is generated.

The viewing status information 52 generated by the sight line analysis device 152 is transmitted to the viewing information collection server 40.

The viewing information collection server 40 stores the collected viewing status information in the viewing information record database 41 connected through the network 35.

The content distribution server 30 can generate the above-described head position (viewpoint position) heat map and gaze point position heat map on the basis of the viewing status information stored in the viewing information record database 41.

Furthermore, processing in accordance with each of the above-described embodiments (A) to (F) can be performed by using these heat maps.

Note that, in the configuration illustrated in FIG. 35, the sight line analysis device 152 generates the viewing status information 52, but an output from the sight line tracking device 151 may be directly transmitted to a sight line information collection server 40 and the viewing status information 52 may be generated at the sight line information collection server 40.

In addition, as for a free viewpoint, video in which, for example, concert audience and crowd are recorded, when the sight line of a person in the content is detected to calculate a heat map, processing similar to the above-described processing can be achieved without acquisition of a sight line information of a viewer directly viewing the content. In this case, the viewing status information is generated by execute analysis of a viewer in the content.

[3. Exemplary Hardware Configuration of the Information Processing Device]

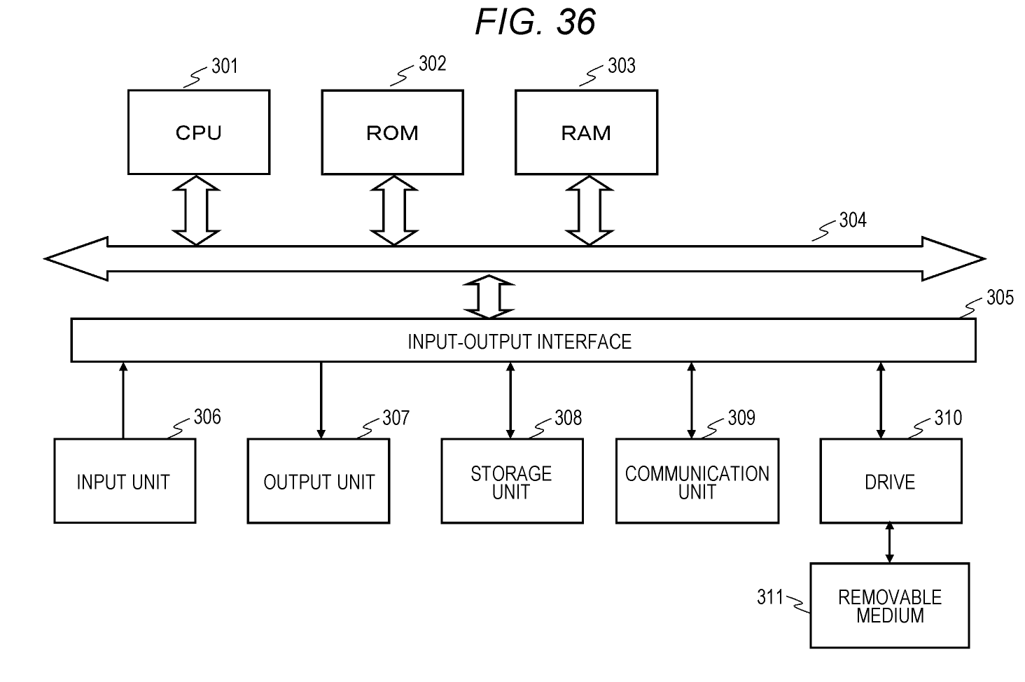

The following describes, with reference to FIG. 36, exemplary hardware configurations of an information processing device included in a server, a PC on the client side, a viewing device, or the like configured to execute processing in accordance with the above-described embodiments, and a server.

A central processing unit (CPU) 301 functions as a data processing unit configured to execute various kinds of processing in accordance with computer programs stored in a read only memory (ROM) 302 and a storage unit 308. For example, the CPU 301 executes processing in accordance with the sequences described above in the embodiments. A random access memory (RAM) 303 stores, for example, the computer programs executed by the CPU 301 and data. The CPU 301, the ROM 302, and the RAM 303 are connected with each other through a bus 304.

The CPU 301 is connected with an input-output interface 305 through the bus 304, and the input-output interface 305 is connected with an input unit 306 including various switches, a keyboard, a mouse, a microphone, and the like, and an output unit 307 including a display, a speaker, and the like. The CPU 301 executes various kinds of processing in response to commands input through the input unit 306, and outputs results of the processing to, for example, the output unit 307.

The storage unit 308 connected with the input-output interface 305 is achieved by, for example, a hard disk or the like, and stores the computer programs executed by the CPU 301 and various kinds of data. A communication unit 309 functions as a transmission-reception unit for data communication through a network such as the Internet or a local area network, and further as a transmission-reception unit for broadcast wave, and performs communication with an external device.

A drive 310 connected with the input-output interface 305 drives a removable media 311 such as a magnetic disk, an optical disk, a magneto optical disc, or a semiconductor memory such as a memory card to execute data recording or reading.

Note that data encoding or decoding can be executed as processing of the CPU 301 as a data processing unit, but a codec as dedicated hardware for executing encoding processing or decoding processing may be provided.

[4. Summary of the Present Disclosure Configuration]

The embodiments of the present disclosure have been described in detail with reference to specific embodiments. However, it is self-evident that those skilled in the art can make modifications and substitutions of the embodiments without departing from the gist of the present disclosure. That is, the present invention has been disclosed in the form of exemplification, and should not be interpreted restrictively. In order to judge the gist of the present disclosure, the scope of claims should be taken into consideration.

Note that the technology disclosed in this specification can have the following configuration.

(1) An information processing device including a data processing unit configured to:

acquire information on viewpoint positions of a plurality of users viewing a content; and

generate a viewpoint position heat map illustrating a distribution status of the viewpoint positions of the users.

(2) The information processing device according to (1), in which the data processing unit further

acquires information on gaze point positions of the plurality of users on the content, and

generates a gaze point position heat map illustrating a distribution status of the gaze point positions of the users.

(3) The information processing device according to (2), in which the data processing unit calculates, as a gaze point position, an intersection point between a sight line direction of each user viewing the content and a display object in the content, and generates the gaze point position heat map.

(4) The information processing device according to any one of (1) to (3), in which

the content is a free viewpoint video content that allows video to be observed is accordance with at least one of a viewpoint position or a sight line direction, and

the data processing unit acquires viewpoint status information including the viewpoint position information on the basis of an output from a sensor provided to a viewing device.

(5) The information processing device according to (4), in which the viewpoint status information is information recording, as temporal sequence data, at least the viewpoint position or the sight line direction of each user viewing the content.

(6) The information processing device according to (5), in which the viewpoint position is the head position of the user.

(7) The information processing device according to any one of (1) to (6), in which the data processing unit generates recommended viewpoint information including a viewpoint position or a gaze point position with a high distribution rate by using at least one heat map of

the viewpoint position heat map illustrating the distribution status of the viewpoint positions of the users viewing the content, or

a gaze point position heat map illustrating a distribution status of gaze point positions of the users viewing the content.

(8) The information processing device according to (7), in which the data processing unit transmits, to a content viewing side client, the recommended viewpoint information and a free viewpoint video content that allows video to be observed in accordance with at least one of a viewpoint position or a sight line direction.

(9) The information processing device according to any one of (1) to (8), in which the data processing unit generates scene switch point information of the content by using at least one heat map of

the viewpoint position heat map illustrating the distribution status of the viewpoint positions of the users viewing the content, or

a gaze point position heat map illustrating a distribution status of gaze point positions of the users viewing the content.

(10) The information processing device according to (9), in which the data processing unit generates the scene switch point information by estimating a scene switch point to be a switch point at which temporal sequence data of the viewpoint position heat map or the gaze point position heat map has a large change amount.

(11) The information processing device according to (9) or (10), in which the data processing unit transmits, to a content viewing side client, the scene switch point information and a free viewpoint video content that allows video to be observed in accordance with at least one of a viewpoint position or a sight line direction.

(12) The information processing device according to any one of (1) to (11), in which the data processing unit sets an advertisement price corresponding to a content region by using a gaze point position heat map illustrating a distribution status of gaze point positions of the users viewing the content, and executes advertisement output control in accordance with the set advertisement price.

(13) The information processing device according to (12), in which the data processing unit

generates, on the basis of the gaze point position heat map, advertisement rank definition information that sets a high advertisement price to a content region having a high gaze point distribution rate, and

executes advertisement output control by using the generated advertisement rank definition information.

(14) The information processing device according to any one of (1) to (13), in which the data processing unit transmits, to a content viewing side client, an encode control content generated by executing encode control corresponding to a content region by using a gaze point position heat map illustrating a distribution status of gaze point positions of the users viewing the content.

(15) The information processing device according to any one of (1) to (14), in which the data processing unit executes charge processing for each content region by using at least one heat map of

the viewpoint position heat map illustrating the distribution status of the viewpoint positions of the users viewing the content, or

a gaze point position heat map illustrating a distribution status of gaze point positions of the users viewing the content.

(16) An information processing system including a server and a client, in which

the server transmits, to the client, a free viewpoint video content that allows video to be observed in accordance with at least one of a viewpoint position or a sight line direction,

the client generates viewing status information including temporal sequence data of a viewpoint position and a sight line direction of a user viewing the content and transmits the viewing status information to the server, and

the server receives the viewing status information from a plurality of clients, and generates at least one heat map of
the viewpoint position heat map illustrating the distribution status of the viewpoint positions of the users viewing the content, or
a gaze point position heat map illustrating a distribution status of gaze point positions of the users viewing the content.

(17) The information processing system according to (16), in which the server calculates, as a gaze point position, an intersection point between a sight line direction of each user viewing the content and a display object in the content, and generates the gaze point position heat map.

(18) An information processing device configured to:

execute processing of receiving, from a server, a free viewpoint video content that allows video to be observed in accordance with at least one of a viewpoint position or a sight line direction and displaying the free viewpoint video content, and

further generate viewing status information including temporal sequence data of a viewpoint position and a sight line direction of a user viewing the free viewpoint video content and transmit the viewing status information to the server.

(19) An information processing method of executing information processing at an information processing device, in which a data processing unit of the information processing device:

acquires information on viewpoint positions of a plurality of users viewing a content; and

generates a viewpoint position heat map illustrating a distribution status of the viewpoint positions of the users.

(20) A computer program that causes an information processing device to execute information processing, the computer program causing a data processing unit of the information processing device to execute:

processing of acquiring information on viewpoint positions of a plurality of users viewing a content; and

processing of generating a viewpoint position heat map illustrating a distribution status of the viewpoint positions of toe users.

In addition, the series of processes described in the specification can be executed by hardware, software, or a combination of both. In the case of executing processing by software, it is possible to install a program recording the processing sequence in a memory in a computer incorporated in dedicated hardware and execute it, or install the program in a general-purpose computer capable of executing various processing and execute it. For example, the program can be recorded in the recording medium in advance. In addition to installing from a recording medium to a computer, the program can be received via a network such as a local area network (LAN), the Internet, etc., and installed on a recording medium such as a built-in hard disk.

It is to be noted that the various processes described in the specification are not only executed in time series in accordance with the description but also may be executed in parallel or individually according to the processing capability of the apparatus for executing the processing or according to necessity. In addition, in this specification, the term “system” refers to a logical group configuration of a plurality of apparatuses, and is not limited to a system in which the apparatuses of each configuration are in the same housing.

### INDUSTRIAL APPLICABILITY

As described above, with a configuration according to an embodiment of the present disclosure, a viewpoint position heat map illustrating a distribution status of viewpoint positions of users viewing a content is generated to enable content and advertisement distribution control by using the heat map.

Specifically, for example, a server transmits, to a client, a free viewpoint video content that allows video to be observed in accordance with a viewpoint position and a sight line direction. The client generates viewing status information including temporal sequence data of the viewpoint positions and sight line directions of the users viewing the content, and transmits the viewing status information to the server. The server receives the viewing status information from a plurality of clients, and generates a viewpoint position heat map illustrating a distribution status of the viewpoint positions of the viewing users, and a gaze point position heat map illustrating a distribution status of gaze point positions of the viewing users. In addition, for example, content distribution control and advertisement distribution control are executed in accordance with the heat maps.

With this configuration, a viewpoint position heat map illustrating a distribution status of viewpoint positions of users viewing a content is generated to enable content and advertisement distribution control by using the heat map.

### REFERENCE SIGNS LIST

10 User (viewer)
20 Viewing device
21 PC
30 Free viewpoint video distribution server
31 Free viewpoint video content database
40 Viewing information collection server
41 Viewing information record database
51 Content (free viewpoint video content)
52 Viewing status information
56 Display object
57 Viewer sight line direction
58 Gaze point.
61 Recommended viewpoint information
70 Viewing device
71 PC
72 HMD
73 PC
74 Portable terminal (smartphone)
81 Scene switch point information
101 Advertisement database
102 Advertisement embedded content
121 Transcode server
122 Transcoded content database
131 Encode control content
141 Charge information database
151 Sight line tracking device
152 Sight line analysis device
301 CPU
302 ROM
303 RAM
304 Bus
305 Input-output interface
306 Input unit
307 Output unit
308 Storage unit
309 Communication unit
310 Drive
311 Removable media

1. An information processing device including a data processing unit configured to:
acquire information on viewpoint positions of a plurality of users viewing a content; and
generate a viewpoint position heat map illustrating a distribution status of the viewpoint positions of the users.

2. The information processing device according to claim 1, wherein the data processing unit further
acquires information on gaze point positions of the plurality of users on the content, and
generates a gaze point position heat map illustrating a distribution status of the gaze point positions of the users.

3. The information processing device according to claim 2, wherein the data processing unit calculates, as a gaze point position, an intersection point between a sight line direction of each user viewing the content and a display object in the content, and generates the gaze point position heat map.

4. The information processing device according to claim 1, wherein
the content is a free viewpoint video content that allows video to be observed in accordance with at least one of a viewpoint position or a sight line direction, and
the data processing unit acquires viewpoint status information including the viewpoint position information on a basis of an output from a sensor provided to a viewing device.

5. The information processing device according to claim 4, wherein the viewpoint status information is information recording, as temporal sequence data, at least the viewpoint position and the sight line direction of each user viewing the content.

6. The information processing device according to claim 5, wherein the viewpoint position is a head position of the user.

7. The information processing device according to claim 1, wherein the data processing unit generates recommended viewpoint information including a viewpoint position or a gaze point position with a high distribution rate by using at least one heat map of
the viewpoint position heat map illustrating the distribution status of the viewpoint positions of the users viewing the content, or
a gaze point position heat map illustrating a distribution status of gaze point positions of the users viewing the content.

8. The information processing device according to claim 7, wherein the data processing unit transmits, to a content viewing side client, the recommended viewpoint information and a free viewpoint video content that allows video to be observed in accordance with at least one of a viewpoint position or a sight line direction.

9. The information processing device according to claim 1, wherein the data processing unit generates scene switch point information of the content by using at least one heat map of
the viewpoint position heat map illustrating the distribution status of the viewpoint positions of the users viewing the content, or
a gaze point position heat map illustrating a distribution status of gaze point positions of the users viewing the content,

10. The information processing device according to claim 9, wherein the data processing unit generates the scene switch point information by estimating a scene switch point to be a switch point at which temporal sequence data of the viewpoint position heat map or the gaze point position heat map has a large change amount.

11. The information processing device according to claim 9, wherein the data processing unit transmits, to a content viewing side client, the scene switch point information and a free viewpoint video content that allows video to be observed in accordance with at least one of a viewpoint position or a sight line direction.

12. The information processing device according to claim 1, wherein the data processing unit sets an advertisement price corresponding to a content region by using a gaze point position heat map illustrating a distribution status of gaze point positions of the users viewing the content, and executes advertisement output control in accordance with the set advertisement price.

13. The information processing device according to claim 12, wherein the data processing unit
generates, on a basis of the gaze point position heat map, advertisement rank definition information that sets a high advertisement price to a content region having a high gaze point distribution rate, and
executes advertisement output control by using the generated advertisement rank definition information.

14. The information processing device according to claim 1, wherein the data processing unit transmits, to a content viewing side client, an encode control content generated by executing encode control corresponding to a content region by using a gaze point position heat map illustrating a distribution status of gaze point positions of the users viewing the content.

15. The information processing device according to claim 1, wherein the data processing unit executes charge processing for each content region by using at least one heat map of
the viewpoint position heat map illustrating the distribution status of the viewpoint positions of the users viewing the content, or
a gaze point position heat map illustrating a distribution status of gaze point positions of the users viewing the content.

16. An information processing system comprising a server and a client, wherein
the server transmits, to the client, a free viewpoint video content that allows video to be observed in accordance with at least one of a viewpoint position or a sight line direction,
the client generates viewing status information including temporal sequence data of a viewpoint position and a sight line direction of a user viewing the content and transmits the viewing status information to the server, and
the server receives the viewing status information from a plurality of clients, and generates at least one heat map of
the viewpoint position heat map illustrating the distribution status of the viewpoint positions of the users viewing the content, or
a gaze point position heat map illustrating a distribution status of gaze point positions of the users viewing the content.

17. The information processing system according to claim 16, wherein the server calculates, as a gaze point position, an intersection point between a sight line direction of each user viewing the content and a display object in the content, and generates the gaze point position heat map.

18. An information processing device configured to:
execute processing of receiving, from a server, a free viewpoint video content that allows video to be observed in accordance with at least one of a viewpoint position or a sight line direction and displaying the free viewpoint video content; and
further generate viewing status information including temporal sequence data of a viewpoint position and a sight line direction of a user viewing the free viewpoint video content and transmit the viewing status information to the server.

19. An information processing method of executing information processing at an information processing device, wherein a data processing unit of the information processing device:
acquires information on viewpoint positions of a plurality of users viewing a content; and
generates a viewpoint position heat map illustrating a distribution status of the viewpoint positions of the users.

20. A computer program that causes an information processing device to execute information processing, the computer program causing a data processing unit of the information processing device to execute:
processing of acquiring information on viewpoint positions of a plurality of users viewing a content; and
processing of generating a viewpoint position heat map illustrating a distribution status of the viewpoint positions of the users.
